(19) United States
(12) Patent Application Publication
(10) Pub. No.: US 2010/0008651 A1
(43) Pub. Date: Jan. 14, 2010

(54) ELECTRONIC APPARATUS AND JOB EXECUTING METHOD

(75) Inventor: Hirokazu YONEKURA, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/500,310

(22) Filed: Jul. 9, 2009

(30) Foreign Application Priority Data
Jul. 10, 2008 (JP) 2008-179849
Apr. 23, 2009 (JP) 2009-104984

(51) Int. Cl. H04N 7/26; H04N 7/173

(52) U.S. Cl. 386/124; 386/E05.001; 725/109

(57) ABSTRACT

A purpose is to provide a user friendly electronic apparatus and a job executing method thereof. When a picture recording request instruction is issued to an HDD recording/reproducing apparatus 110 installed on a second floor by an operation of a user, in such a case that a hard disk drive 201_{—}2 of the HDD recording/reproducing apparatus 110 has no remaining storage capacity, if a hard disk drive 201_{—}1 of another HDD recording/reproducing apparatus 105 installed on the down stair has a remaining storage capacity, then a central control unit 306 judges that the hard disk drive 201_{—}1 of the HDD recording/reproducing apparatus 105 installed on the down stair can be used. Sound and picture signals tuned by a tuner 204_{—}2 of the HDD recording/reproducing apparatus 110 are transmitted to the hard disk drive 201_{—}1 of the HDD recording/reproducing apparatus 105 so as to be recorded on this hard disk drive 201_{—}1.

### BACKGROUND

1. Field of the Invention

The present invention relates to an electronic apparatus such as, for instance, a television set and a recording/reproducing apparatus, which are used in home, and relates to a job executing method for the electronic apparatus.

2. Description of the Related Art

In homes, for instance, while television sets and recording/reproducing apparatuses are employed, television programs are recorded on the recording/reproducing apparatuses and thereafter the recorded television programs are reproduced in order to avoid that users may forget to watch the above-described television programs. One example as to very user-friendly recording/reproducing apparatuses capable of recording thereon television programs and thereafter reproducing the recorded television programs has been described in a patent literature 1.

Also, a home electronic apparatus remote control system has been proposed in a patent literature 2. That is, in the home electronic apparatus remote control system, while the remote control system includes a home electronic apparatus having a communication function and a home controller for controlling the home electronic apparatus in a remote control manner, the remote control system sets whether or not a remote operation is permitted with respect to each function of the home electronic apparatus, and then, designates an authentication level thereof. The home electronic apparatus has a communication function by assembling a controller, and is communicated with a communication terminal via a PPP (Point to Point Protocol) server of a provider. While a LAN control unit is provided in the remote control system, this remote control system controls the home electronic apparatus via the Internet in the remote control manner. In the home electronic apparatus remote control system, while a controller having a communication function is provided in each of home electronic apparatuses, the remote control system authenticates whether or not an operation of a main body (home electronic apparatus) is permitted with respect to a function of each of these home electronic apparatuses, for example, each code of function names (operation is started, stopped, and so on) in a washing machine, a refrigerator, and the like.

Moreover, a recording operation reserving system has been proposed in a patent literature 3. That is, while a plurality of recording/reproducing apparatuses are provided in the recording operation reserving system, a recording operation reserving apparatus grasps empty storage capacities of recording media employed in the recording/reproducing apparatuses and also reservation situations so as to select an optimum recording/reproducing apparatus, and thus, performs a picture recording operation by the selected recording/reproducing apparatus.

As previously explained in the patent literature 1, if the television set and the recording/reproducing apparatus are provided in the home, then the user can view the recorded television program later, so that this recording/reproducing apparatus can become very user friendly. However, in such a case that the user tries to record the television program, if the storage capacity of the storage apparatus employed in this recording/reproducing apparatus are brought into a substantially memory full condition, even when a recording operation of the television program is newly set, the remaining storage capacity of this storage apparatus cannot accept this recording operation. As a result, the recording/reproducing apparatus can no longer reserve the television program. Under such a circumstance, the user firstly confirms contents of the previously recorded television programs, and secondly erases a portion of these recorded television programs so as to newly record the desirable television program. Otherwise, if another set of recording/reproducing apparatus is provided in the home, then there are some possibilities that the user tries to record the desirable television program by utilizing this additional recording/reproducing apparatus. However, in any of the former case and the later case, the below-mentioned cumbersome operations are necessarily required, which deteriorates the user-friendly aspect. That is, when the remaining storage capacity cannot accept the new program setting operation, the user must set the television program after erasing the presently used storage capacity. Otherwise, the user must move to another place where the program setting operation is performed on another recording/reproducing apparatus.

Also, in the home electronic apparatus remote control system described in the patent literature 2, the communication terminal accesses from the external network to the home electronic apparatuses, such a home electronic apparatus managed by the PPP server is connected to the external network, and thus, the respective functions of this home electronic apparatus are operated in the remote control manner. As a consequence, in such a remote control system, a content of a remote control operation may be determined by such a condition that the user wants to execute which operation of which home electronic apparatus. There are some possibilities that the same sorts of home electronic apparatuses are connected to a certain system, for example, a plurality of recording/reproducing apparatuses are connected to the recording operation reserving system as described in the patent literature 3. However, in the above-described remote control system of the patent literature 2, the individual recording/reproducing apparatuses are controlled in the perfectly separate control manners.

In most opportunities, aspects required by these users are given as follow: The users merely accept that any one of home electronic apparatuses may be operated so as to realize a target function of the selected one home electronic apparatus, but these users have no such an intention that a specific one home electronic apparatus may be operated. For instance, as previously explained, in such a case that two, or more sets of recording/reproducing apparatuses are provided, if desirable picture signal can be recorded on any one of these plural recording/reproducing apparatuses, and furthermore, if a user can operate another recording/reproducing apparatus in order to record and/or reproduce picture data, then the requirement of this user can be fully satisfied. Then, in addition, the user wants to realize a desirable function (operation result) in any way irrespective of a processing history, rather than realizing of the desirable function by employing any one of these recording/reproducing apparatuses.

As previously described, the related electronic apparatuses can be hardly matched with needs of the users, and therefore, are not user-friendly electronic apparatuses.

[Patent literature 1] JP-A-2007-150912

[Patent literature 2] JP-A-2004-96591

[Patent literature 3] JP-A-2007-173918

The present invention has been made to solve the above-described problems, and therefore, the present invention has an object to provide a user friendly electronic apparatus, and a job executing method for the electronic apparatus.

### SUMMARY

To achieve the above-described object, an electronic apparatus of the present invention comprises:

a control section that receives a request of a job;

a functional component that executes the job; and

a communication section by which the functional component communicates with another electronic apparatus via a network,

wherein the functional component executes the job together with a functional component provided in the another electronic apparatus by performing a data communication with the functional component of the another electronic apparatus by the communication section.

By the above configuration of the electronic apparatus, the electronic apparatus executes the job together with the functional component of another electronic apparatus, so that a user friendly electronic apparatus can be realized.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram for representing an entire electronic apparatus utilizing system according to an embodiment 1 of the present invention;

FIG. 2 is a block diagram for showing an arrangement of an HDD recording/reproducing apparatus corresponding to one example of the electronic apparatus of FIG. 1;

FIG. 3 is a block diagram for indicating an arrangement of a refrigerator corresponding to another example of the electronic apparatus of FIG. 1;

FIG. 4 is a block diagram for representing an arrangement of a television set corresponding to another example of the electronic apparatus of FIG. 1;

FIG. 5 is a diagram for indicating an electronic apparatus system of the embodiment 1 which constructs a virtual electronic apparatus;

FIG. 6 is a structural diagram for explaining data flows of the electronic apparatus system shown in FIG. 5;

FIG. 7 is a diagram for showing use situations of structural components of the electronic apparatus system shown in FIG. 5;

FIG. 8 is a flow chart for describing operations of the electronic apparatus system indicated in FIG. 5;

FIG. 9 is an explanatory diagram for explaining a control sequence performed in an electronic apparatus system of the embodiment 1;

FIG. 10 is a diagram for representing data flows which are executed between electronic apparatuses of the electronic apparatus system shown in FIG. 9;

FIG. 11 is a structural diagram for explaining data flows between electronic apparatuses of an electronic apparatus system according to an embodiment 2 of the present invention;

FIG. 12 is a flow chart for explaining operations of the electronic apparatus system shown in FIG. 11;

FIG. 13 is a structural diagram for explaining data flows between electronic apparatuses of an electronic apparatus system according to an embodiment 3 of the present invention;

FIG. 14 is a flow chart for explaining operations of the electronic apparatus system shown in FIG. 13; and

FIG. 15A is an explanatory diagram for explaining a dip switch which switches utilizing modes of electronic apparatuses according to an embodiment 4 of the present invention, and FIG. 15B is an explanatory diagram for explaining a system setting unit which switches utilizing modes of an electronic apparatus utilizing system according to the embodiment 4 of the present invention.

### DETAILED DESCRIPTION OF EXEMPLARY EMBODIMENTS

Referring now to embodiments 1 through 4, a description is made of concrete contents of the present invention.

### Embodiment 1

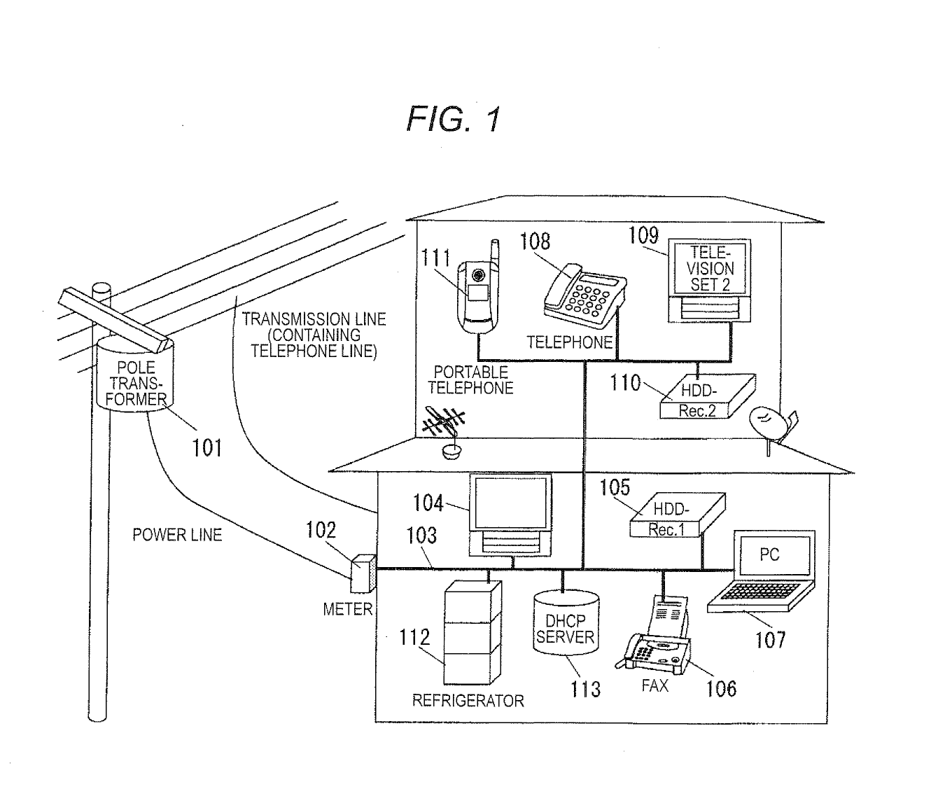

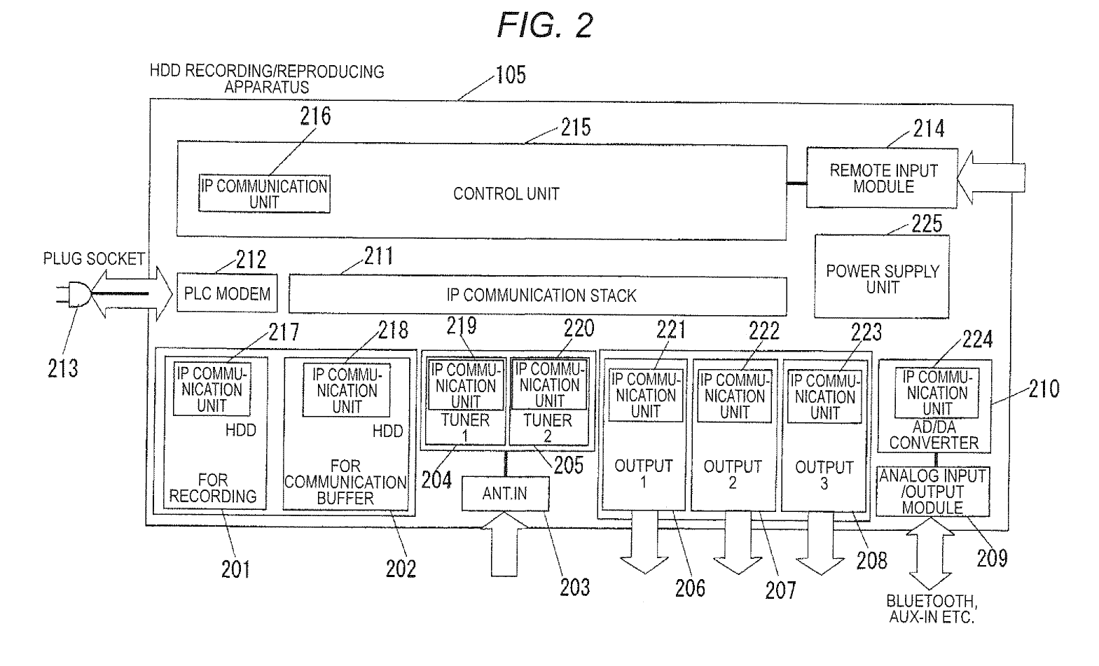

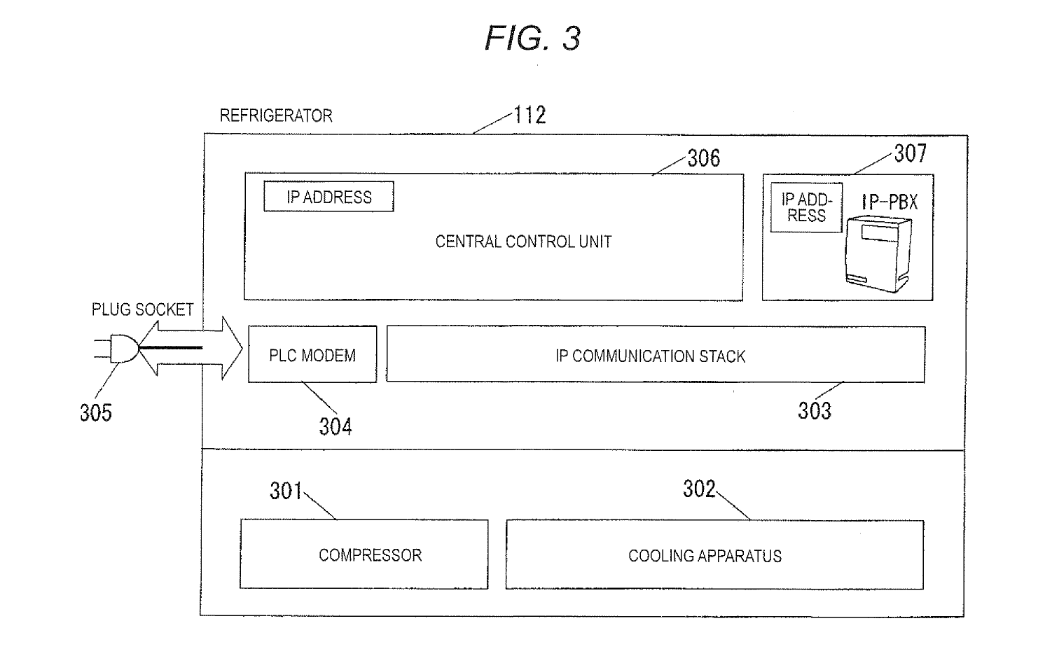

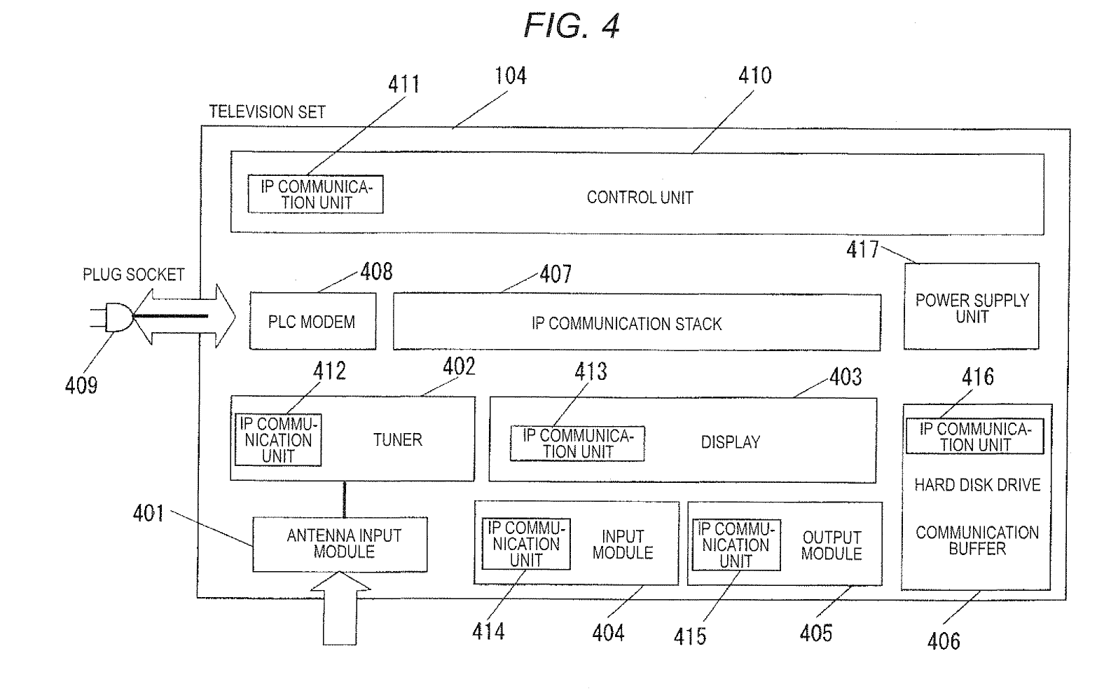

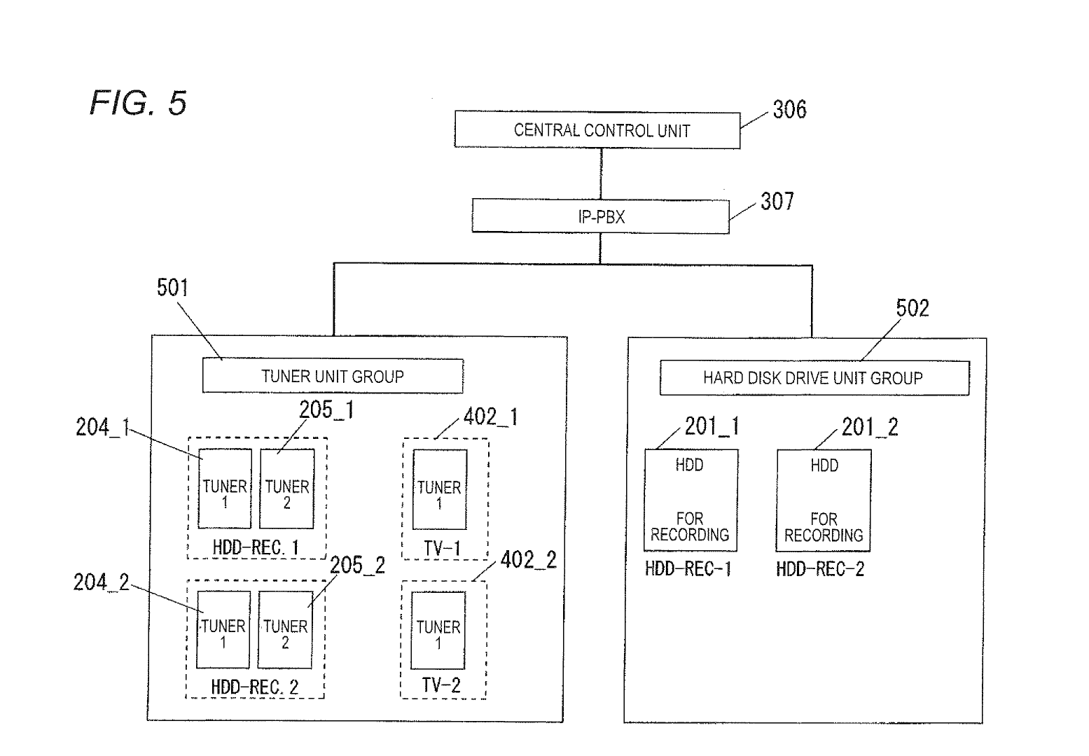

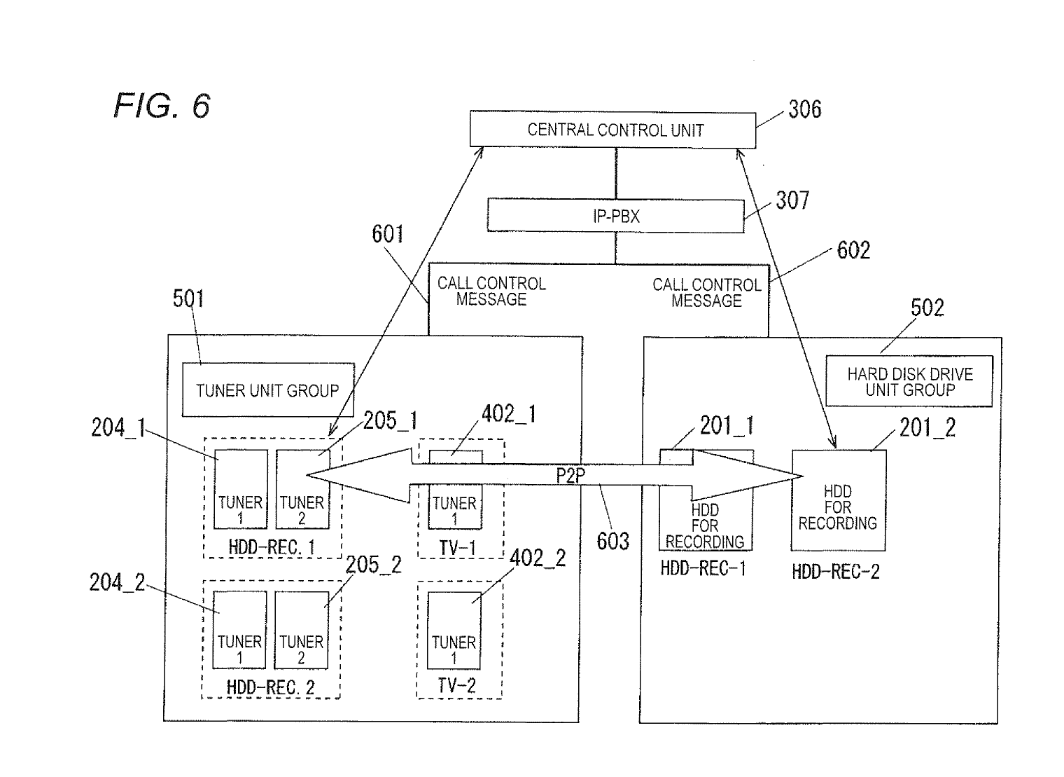

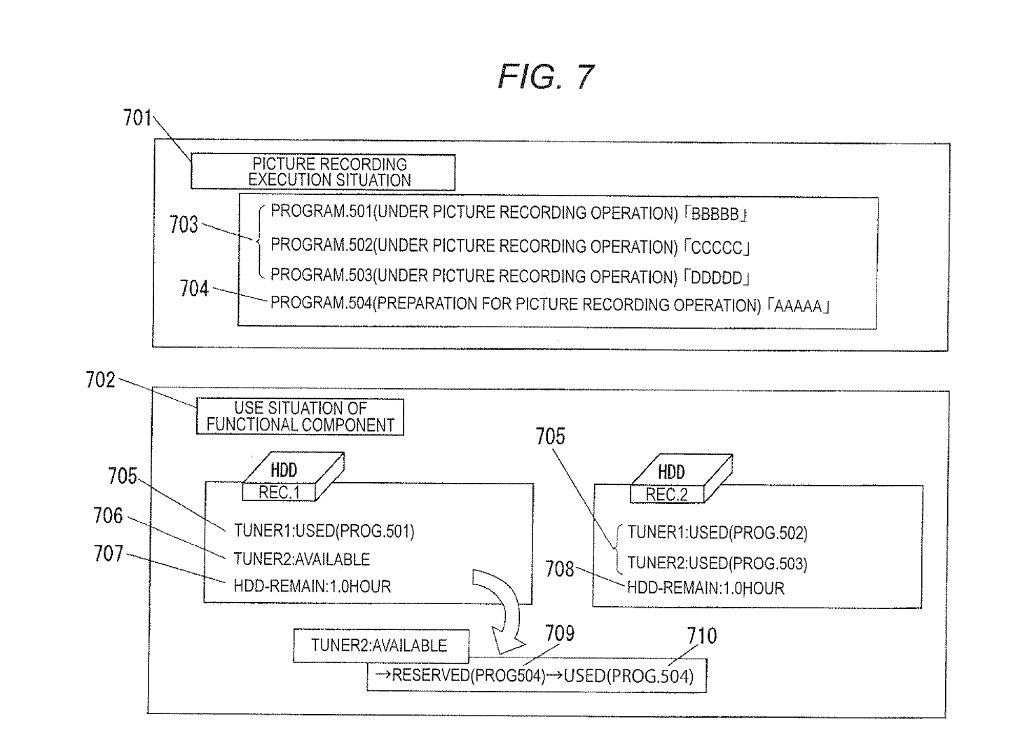

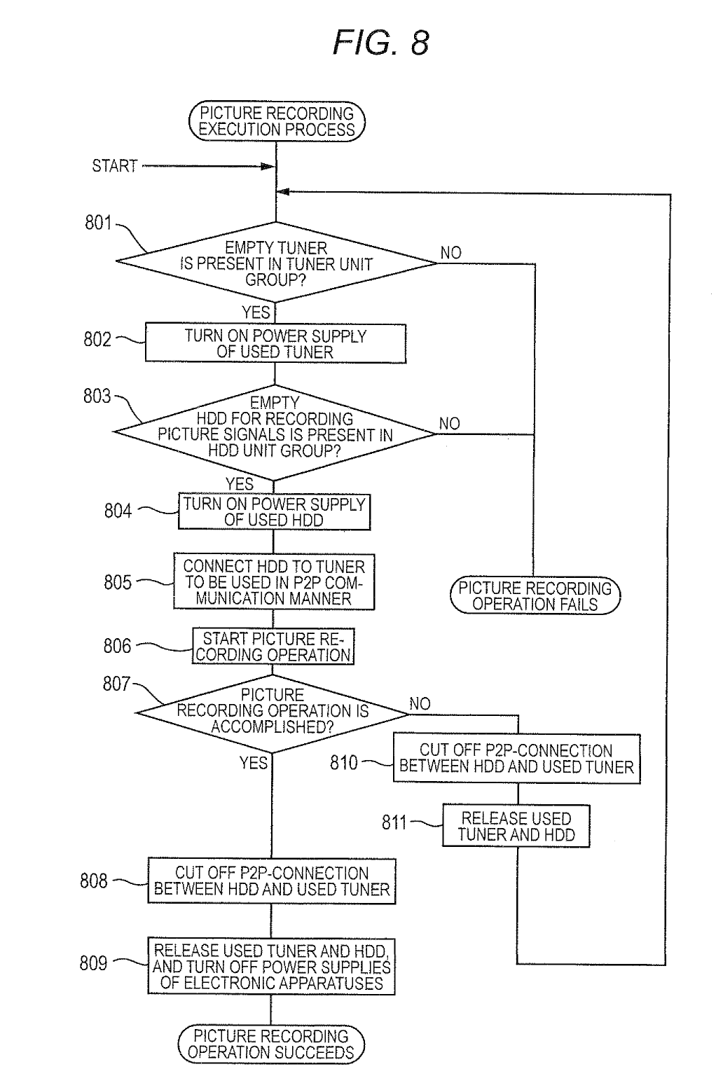

A description is made of electronic apparatuses according to an embodiment 1 of the present invention, and an electronic apparatus utilizing system with employment of the electronic apparatuses with reference to FIG. 1 through FIG. 8. FIG. 1 is a diagram for representing an entire electronic apparatus utilizing system according to the embodiment 1. FIG. 2 is a block diagram for showing an arrangement of an HDD recording/reproducing apparatus corresponding to one example of the electronic apparatus. FIG. 3 is a block diagram for indicating an arrangement of a refrigerator corresponding to another example of the electronic apparatus. FIG. 4 is a block diagram for representing an arrangement of a television set corresponding to another example of the electronic apparatus. FIG. 5 is a diagram for indicating an electronic apparatus system of the embodiment 1 which constructs a virtual electronic apparatus. FIG. 6 is a diagram for explaining data flows of the electronic apparatus system shown in FIG. 5. FIG. 7 is a diagram for showing use situations of structural components of the electronic apparatus system shown in FIG. 5. FIG. 8 is a flow chart for describing operations of the electronic apparatus system indicated in FIG. 5.

FIG. 1 represents one embodiment of the present invention as an electronic apparatus utilizing system provided in each of homes. In other words, while this house is made as a two-story building, a voltage (6600 V) of a power supply is transformed to another voltage (100 V) via a pole transformer 101, and then, the transformed voltage of 100 V is conducted via a meter 102 to the house. Then, although not indicated in detail, the voltage (100 V) of the power supply is applied to respective electronic apparatuses. A power line conducted to the meter 102 shown in FIG. 1 is indicated as a electric supplying line 103. Then, a television set 104, an HDD (Hard Disk Drive) recording/reproducing apparatus 105, a FAX (Facsimile) 106, and a PC (Personal Computer) 107, which correspond to the electronic apparatuses, are connected via plug sockets (not shown) of the power supply to the electric supplying line 103 on a first floor of the house. Also, a telephone 108, another television set 109, and another HDD recording/reproducing apparatus 110, which correspond to the electronic apparatuses, are connected via plug sockets (not shown) of the power supply to the electric supplying line 103 on a second floor of the house. A portable telephone 111 is connected to the electric supplying line 103 via a recharging-purpose adaptor (not shown). In addition, a DHCP (Dynamic Host Configuration Protocol) server 113, and a refrigerator 111 (will be explained later) functioning as the electronic apparatus are connected to the electric supplying line 103, while the DHCP server 113 allocates IP address to these electronic apparatuses. These electronic apparatuses installed in the house are connected to each other under communicatable situations, and construct a network within the house, and also, are connected to an external network by employing transfer lines which contain telephone lines.

Next, the HDD recording/reproducing apparatus 105 corresponding to one of these electronic apparatuses has such an internal arrangement as represented in FIG. 2. As shown in FIG. 2, the HDD recording/reproducing apparatus 105 includes a large number of functional components. In this case, a functional component implies such a component having a function capable of playing a certain role. Concretely speaking, these functional components correspond to a hard disk drive (HDD) 201 for recording thereon picture signals, a communication buffer-purpose hard disk drive 202, tuners 204 and 205 which input thereinto information supplied from an antenna input module 203, output modules 206 to 208, and an AD/DA converter 210 which is connected to an analog input/output module 209.

The HDD recording/reproducing apparatus 105 includes an IP communication stack 211, a PLC (Power Line Communication) modem 212, a power supply plug 213, a remote input module 214, and a control unit 215 which controls these structural components 211 to 214. The IP communication stack 211 corresponds to a software group which provides a network function. The PLC modem 212 corresponds to an adaptor which superimposes a data communication-purpose signal to the electric supplying line 103. The remote input module 214 corresponds to a module via which a user operates the HDD recording/reproducing apparatus 105 in a remote manner. In other words, the electric supplying line 103 may be also referred to as a signal transfer path which constructs an indoor network. However, in a power line communication, a signal is superimposed on a power supply voltage so as to perform a communication by the PLC modem 212. As a result, the signal does not leak from the indoor functional components through the meter 102 and the pole transformer 101 to an external area.

In this embodiment 1, the control unit 215 of the HDD recording/reproducing apparatus 105 causes an IP address of the HDD recording/reproducing apparatus 105 to be held in a setting memory (not shown) of the IP communication unit 216. An electronic apparatus can perform a communication on a network layer (IP layer) by using an IP address. It should be understood that an IP address implies such an address by which an electronic apparatus can be discriminated from other electronic apparatuses on an IP (Internet Protocol) network. In the IPv4 protocol, a private IP address is suitable to the IP address, for example, a 32-bit address such as class C (192.168.0.0-192.168.255.255) is applied thereto. Based upon the IP address, the HDD recording/reproducing apparatus 105 is brought into such an information communicatable situation that the information as to this HDD picture recording/reproducing apparatus 105 can be communicated with other electronic apparatuses within the home via the electric supplying line 103 via the network layer (IP layer). In this embodiment 1, although the HDD recording/reproducing apparatus 105 performs a communication via the electric supplying line 103, the present invention is not limited only to the power line communication, but may be alternatively realized by employing an optical communication, a wireless communication, and the like.

Also, with respect to the functional components such as the hard disk drives 201 and 202, and the tuners 204 and 205, functional component addresses corresponding to addresses of these functional components themselves are held in setting memories (not shown) of the IP communication units 217 and 218, and also the IP communication units 219 and 220. These functional components 201, 202, 204, and 205 can be communicated with other functional components on network layers by utilizing the functional component addresses. These functional components addresses are required to constitute such addresses capable of identifying components at least on the network layers (IP layers). As a consequence, the HDD recording/reproducing apparatus 105 eventually has the own IP address, and at the same time, the respective functional components have functional component addresses, respectively. Similarly, while the output modules 206 to 208 are equipped with IP communication units 221 to 223 and the AD/DA converter 210 is equipped with an IP communication 224, functional component addresses have been held in setting memories thereof (not shown). Even when a relay apparatus such as a router is present on a network established within the home, electronic apparatuses and functional components can perform IP communications with each other based upon IP addresses and functional component addresses.

As previously described, an IP communication unit such as the IP communication unit 216 and the IP communication unit 217 holds either an IP address or a functional component address, and can perform an IP communication in an application layer, which is equivalent to an IP telephone by the IP communication stack 211. In other words, the IP communication stack 211 corresponds to such a software group that communication programs defined from lower-grade communication programs standardized by TCP/IP, UDP/IP, and the like up to higher-grade communication programs have been grouped. At least, an upper-grade communication program standardized by a call control program such as SIP (Session Initiation Protocol), H. 323, and the like are installed as an application program on the IP communication stack 211. An IP communication unit can perform a call connection by using this IP communication stack 211, and can perform an IP communication equivalent to an IP telephone communication.

All the IP communication units acquire IP addresses from the DHCP server 113 of FIG. 1, and then, store the acquired IP addresses into setting memories provided in the own IP communication units. A functional component address and information such as a sort of functional component are stored in a setting memory. It should be noted that the DHCP server 113 may be alternatively set at any place within the network, for example, may be set in the refrigerator 112.

Also, the HDD recording/reproducing apparatus 105 is equipped with a power supply unit 255. Then, if the power supply plug 213 has been connected to the plug socket, then the control unit 215, the IP communication stack 211, and the PLC modem 212 have been brought into operable situations due to stand-by electric power even when the power supply unit 225 is not turned ON. As a result, even if the power supply unit 225 is not turned ON, information may be communicated with other electronic apparatuses.

Also, although the HDD recording/reproducing apparatus 105 are exemplified, another HDD recording/reproducing apparatus 110 has a similar arrangement to that of the HDD recording/reproducing apparatus 105. Accordingly, in such a case that the HDD recording/reproducing apparatuses 105 and 110 are required to be discriminated from each other in the below-mentioned descriptions, either reference numeral “_1” or reference numeral “_2” will be applied, for example, “hard disk drive 201_1.” In the below-mentioned descriptions, when the reference numeral “_1” is applied to functional components, these functional components correspond to such functional components of the HDD recording/reproducing apparatus 102 provided on the first floor, whereas when the reference numeral “_2” is applied to functional components, these functional components correspond to such functional components of the HDD recording/reproducing apparatus 110 provided on the second floor.

Further, although the IP addresses have been exemplified in the example, specific addresses may be alternatively applied to functional component addresses, respectively. The reason why such specific addresses may be applied is given as follows: That is, while the control unit 215 manages the respective functional component addresses, the control unit 215 may convert a functional component address into an IP address based upon a corresponding relationship, and may perform a communication as a representative unit by employing the IP address of the control unit 215 instead of the functional component address. In such a case that the DHCP server 113 allocates the IP addresses to all the IP communication units, a functional component address contains an allocated IP address.

In the embodiment 1, for instance, as a functional component address, such a logical identifier is employed. The logical identifier is constituted by address information (IP address and MAC address), a component number (serial number corresponding to extension number) provided inside an electronic apparatus, and a number which indicates a sort (for example, group sort of hard disk drive) of the above-described functional component. That is, a functional component address is arranged by an upper-grade logical identifier corresponding to component information, a middle-grade (network layer) of an IP address corresponding to address information, and a lower-grade (physical layer) MAC address. As this logical identifier, assuming now that the component number is “012”, and the number indicative of the sort of functional component is “345”, the logical identifier may be expressed by, for instance, (012. 345) as an IP address. If this functional component address is used, then a P2P (Peer to Peer) communication may be carried out by using the network layer. In other words, in accordance with this communication, data of one functional component can be directly transferred to another functional component by the P2P communication manner. Also, if a logical identifier is given, then a sort of a functional component may be easily specified based upon the number thereof.

Alternatively, while the PLC modem 212 may be equipped with an IP communication unit, an IP address held in this IP communication unit may be defined as such a representative IP address of the HDD recording/reproducing apparatus 105. The reason of this alternative example is given as follows: Since the PLC modem 212 constitutes an interface unit in a data communication executed between the electric supplying line 103 and an electronic apparatus, the held IP address may be easily handled as an IP address of such a representative host of electronic apparatuses.

It should also be noted that an LAN adaptor may be alternatively employed which performs a communication operation instead of the PLC modem 212. The reason of this alternative example is given as follows: That is, the LAN adaptor may also constitute an interface unit in a data communication operation such as Ethernet (registered trademark). In the case that LAN adaptors are employed, a LAN cable is routed within a home, and such a LAN adaptor is also provided in another electronic apparatus in order to connect this LAN adaptor to the LAN cable.

Also, since the communication buffer-purpose hard disk drive 202 is set, congestion of network traffics may be suppressed when a large capacity of information is communicated.

Moreover, as will be discussed later, while another electronic apparatus such as a television set has the own IP address, respective functional components of this electronic apparatus may furthermore have functional component addresses.

Next, a description is made of process operations executed in the electronic apparatus utilizing system in the home when, for example, a certain television program “aaaaa” is recorded on the HDD recording/reproducing apparatus 105 or 110.

When a user intends to record the television program “aaaaa” on the HDD recording/reproducing apparatus 110 installed on the second floor in FIG. 1, the user operates a remote controller (not shown) so as to enter a picture recording instruction (job request) such as picture recording start/end times and either a channel or a program code to the HDD recording/reproducing apparatus 110.

As a result, first of all, the control unit 215 which has received the picture recording instruction via the remote input module 214 of FIG. 2 checks conditions of the respective functional components related to the picture recording instruction in the HDD recording/reproducing apparatus 110. As a result of the checking operation, if the relevant functional components are under usable conditions, then the control unit 215 executes a picture recording reservation and a picture recording operation. Then, antenna input information is tuned by, for example, a tuner 204, and sound/picture signals are transmitted with respect to the hard disk drive 201 in order to record thereon the television program “aaaaa.”

However, in such a case that if the entire storage capacity of the hard disk drive 201 for recording pictures is entirely recorded by television programs which had been recorded in the past, then this hard disk drive 201 can no longer record any television program, the control unit 215 performs the below-mentioned operations. That is, the control unit 215 executes an information communication with respect to a central control unit (will be explained later) so as to seek whether or not such a hard disk drive having a remaining storage capacity capable of recording pictures is present in other electronic apparatuses (for instance, HDD recording/reproducing apparatus 105 installed on first floor) within the home. Then, if such a hard disk drive is found out, then the control unit 215 transmits the sound/picture signals tuned by the tuner 204 of the HDD recording/reproducing apparatus 110 installed on the second floor with respect to the hard disk drive 201 of the HDD recording/reproducing apparatus 105 installed on the first floor (down stair), the storage capacity of which is empty, in order to record the television program “aaaaa” on this hard disk drive 201. If the above-described operation is performed by the control unit 512, then the user can instantaneously perform the picture recording operation and the picture recording reserving operation by utilizing the HDD recording/reproducing apparatus 105 installed on the first floor, while the user need not perform an erasing operation for erasing the recorded contents of the HDD recording/reproducing apparatus 110 installed on the second floor, the storage capacity of which has been fully recorded by the past television programs. As a consequence, the electronic apparatus of the embodiment 1 can become very user-friendly.

It should also be understood that the example has exemplified that the control unit 215 which receives the picture recording instruction firstly checks the situations of the respective functional components related to the picture recording instruction and provided in the HDD recording/reproducing apparatus 110. Alternatively, the control unit 215 may perform the information communication with respect to the central control unit in the beginning, and may seek whether or not there is such a hard disk drive having a remaining storage capacity capable of recording thereon picture data among all the electronic apparatuses within the home, which cover the own electronic apparatus, so as to issue a picture recording instruction. This operation will be described in detail.

On the other hand, when the control unit 215 performs the operation, such a central control unit is necessarily required within the home, while the central control unit controls a network in order to seek and operate the HDD recording/reproducing apparatus 105 installed on the first floor from the HDD recording/reproducing apparatus 110 installed on the second floor. The central control unit connects functional components having IP communication units with each other in a flexible manner so as to provide these connected functional components as if these function components were a single virtual electronic apparatus. On this central control unit, such a function as the call control server is mounted, which is known as an SIP server and an H. 323 server. In the embodiment 1, it is so designed that the function as the central control unit is given to the refrigerator 112 provided on the down stair. Since the refrigerator 112 is continuously turned ON by the power supply, which is different from other electronic apparatuses, the central control unit having such a function is installed in the refrigerator 112.

FIG. 3 is a block diagram for indicating an internal arrangement of the refrigerator 112. While the refrigerator 112 has a compressor 301 and a cooling apparatus 302 which plays the function of the normal refrigeration, the refrigerator 112 has an IP communication stack 303, a PLC modem 304, a power supply plug 305, a central control unit 306, and an IP-PBX 307, which constitute the feature of the embodiment 1.

In the refrigerator 112, duplicated descriptions as to the same structural components (for example, IP communication stack 303) as those of FIG. 2 will be omitted. Although not shown in the drawing, the refrigerator 112 further includes a power supply unit. The central control unit 306 performs a control operation in such a manner that functional components of respective electronic apparatuses such as the HDD recording/reproducing apparatus 105 are connected to each other in a flexible manner by employing the IP-PBX 307 as if these functional components were a single virtual electronic apparatus. The IP-PBX 307 corresponds to software having a function capable of performing a call control operation in an IP communication. Alternatively, an IP exchanging apparatus functioning as an apparatus (hardware) may be installed. The IP-PBX 307 monitors situations of electronic apparatuses so as to acquire situation information of these monitored electronic apparatuses. When a use instruction is produced in a network, if a call setting command (“MakeCall”) is transmitted from the central control unit 306 based upon the produced use instruction, the IP-PBX 307 issues transmission instructions with respect to the mutual functional components to which data is wanted to be transmitted, and then, sets up a call setting operation (“SETUP”) from one functional component to another functional component so as to transfer the data between the functional components in the P2P communication manner.

In this case, the call setting command (MakeCall) which is transmitted from the central control unit 306 with respect to the IP-PBX 307 corresponds to a telephone call (in this case, telephone call with respect to IP-PBX 307) from a computer (namely, central control unit 306) based upon the CTI (Computer Telephony Integration) technique which integrates a telephone technique with a computer technique. As a consequence, the call setting command (MakeCall) described in this example implies such a command which is employed when the central control unit 306 calls the IP-PBX 307, and the IP-PBX 307 issues calls with respect to the respective functional components.

Then, when the IP-PBX 307 is utilized, the above-described telephone technique is utilized. Accordingly, while a large number of stored techniques are presently available, these stored telephone techniques have high reliability, and can easily prevent illegal accesses. As previously explained, the IP-PBX 307 controls both the IP communication unit 219 of the tuner 204 provided in the HDD recording/reproducing apparatus 110 on the second floor, and the IP communication unit 217 of the hard disk drive 201 provided in the HDD recording/reproducing apparatus 105 on the down stair based upon the call control operation in a similar manner to that of IP telephones.

As previously explained in the arrangements of the HDD recording/reproducing apparatuses 105 and 110, he central control unit 306 and the IP-PBX 307 are equipped with IP communication units, while the respective IP communication units have held IP addresses which have been allocated from the DHCP server 113.

All the IP communication units 216 to 224 which are mounted in the HDD recording/reproducing apparatus 110 installed on the second floor and in the HDD recording/reproducing apparatus 105 installed on the first floor register such information required to execute IP communications with respect to the IP-PBX 307. The information to be registered in the IP-PBX 307 is, for instance, stored IP addresses and functional component addresses of the own IP communication units, and sorts of functional components (for instance, “tuner”, “hard disk drive” etc.) related in correspondence with the respective IP communication units. If such an address containing a logical identifier is used as a functional component address, then this sort can be immediately specified from a sort number of a functional component contained in the logical identifier. When an electronic apparatus is installed, a structural component changes, and the like, information registering operation is carried out.

The IP-PBX 307 classifies functional components as groups based upon the sort information of the functional components registered by the IP communication units 216 to 224, and manages the functional components corresponding to the respective IP communication units 216 to 224 as members of the respective groups. Then, the information about the groups under management is notified from the IP-PBX 307 to the central control unit 306, so that the information of the groups is stored in the central control unit 306. For instance, on a network within a home, respective hard disk drives are collected so as to form a hard disk drive unit group which can be controlled. In other words, when a certain hard disk drive is used, the central control unit 306 can perform such a control operation that which hard disk drive contained in the hard disk drive unit group is utilized. Similarly, when a certain tuner is used, the central control unit 306 can perform such a control operation that which tuner contained in a tuner unit group is utilized. When the central control unit 306 controls the respective electronic apparatuses, the central control unit 306 refers to the information of this group, and call-connects functional components to each other which are wanted to be used, and then, issues initiation requests with respect to the respective functional components so as to transfer data.

It should also be understood that the information which has been managed by the central control unit 306 is mainly such an information which is used to provide services for controlling electronic apparatuses, whereas the information which has been managed by the IP-PBX 307 is such an information related to connections and disconnections of calls when functional components are assumed as IP telephones. In summary, the central control unit 306 manages the service information (namely, information related to operation situations, picture recording situations, and remaining storage capacity information of electronic apparatuses) of the respective electronic apparatuses, whereas the IP-PBX 307 monitors the respective electronic apparatuses, and upon receipt of notification of situation information thereof the IP-PBX 307 manages the acquired situation information by the own IP-PBX 307 and also notifies the acquired situation information to the central control unit 306.

To this end, the IP communication units 216 to 224 transmit the situation information of the functional components in proper timing with respect to the IP-PBX 307 in addition to the registration information. The situation information to be transmitted corresponds to operation situations (under operation/stand-by situation/under notification of abnormal event etc.) of the respective functional components, situations of storage capacities (remaining storage capacity of hard disk drive 201 etc.), situations of picture recording (recording program list etc.). While the IP-PBX 307 monitors situations of functional components, when a situation of a functional component changed, the IP-PBX 307 updates the information, and notifies the updated information to the central control unit 306.

When a use instruction is issued from any one of the electronic apparatuses, the central control unit 306 views service information of the respective electronic apparatuses, and in such a case that functional components are required to be substituted, the central control unit 306 combines the functional components with each other, and then, notifies a call setting command (“MakeCall”) by designating the relevant functional component with respect to the IP-PBX 307. Upon receipt of this call setting command, the IP-PBX 307 establishes such a data path for executing an IP communication between the functional components by the P2P communication manner. A data transfer operation is carried out by using this established data path.

Since the central control unit 306 and the IP-PBX 307 divide functions thereof (sharing of control operations) in the above-described manner, the control operation executed by the IP-PBX 307 can be specified to such a call control operation that the IP-PBX 307 monitors the functional components, and connects a call, and also disconnects a call. Also, the control operation executed by the central control unit 306 can be specified as such a server capable of providing services for controlling electronic apparatuses based upon the information notified from the IP-PBX 307 in a flexible manner. Moreover, since the central control unit 306 and the IP-PBX 307 share the control operations thereof in the above-described manner, the central control unit 306 and the IP-PBX 307 can download the respective functional software via the Internet so as to update the presently downloaded functional software.

The technique of the IP-PBX 307 belongs to such a telephone technique having high security and high reliability, and corresponds to such a suitable technique capable of transferring data between functional components. Even when an electronic apparatus is additionally provided, the IP-PBX 307 may merely perform an extension setting operation similar to that of a telephone set, and may be easily handled. In addition, as will be discussed below, in accordance with the IP-PBX 307, a technique of an electronic conference system may be utilized by which a group call receiving operation for causing a telephone call to be received by one group within groups can be performed, information can be transferred to another one group within the groups, and the information can be mixed.

Firstly, a description is made of such a case that the group call reception is utilized by the IP-PBX 307. That is, in such a case that the IP-PBX 307 wants to use any one functional component within functional components belonging to a certain functional component group, a response request is transmitted from the IP-PBX 307 to the functional components within this functional component group in a batch manner; and if one arbitrary functional component belonging to this functional component group responds to this call request then the. IP-PBX 307 permits a use of this functional component. In other words, the IP-PBX 307 transmits the response request (“NOTIFY”) to the functional components within the group in the batch manner; when there is such a functional component which responds to this response request, the IP-PBX 307 causes this functional component to perform a call setting operation with respect to a counter functional component, and to notify that no response is required to the remaining functional components which do not issue responses. Since such a group call receiving operation is utilized, the central control unit 306 no longer executes all the judging operations and all the control operations, so that such a partial function can be entrusted to the IP-PBX 307 and an further to autonomous control of a functional component. For example, when a picture signal is recorded on the HDD recording/reproducing apparatus 105, or 111, since the central control unit 306 merely instructs the IP-PBX 307 to perform the group call receiving operation, the IP-PBX 307 can transmit the response request to hard disk drive provided within the hard disk unit group in the batch manner, and thus, the IP-PBX 307 can record the picture on such a hard disk drive which issues a response. It should be noted that the IP-PBX 307 notifies the information as to the hard disk drive which has issued the response with respect to the central control unit 306.

Also, when the central control unit 306 notifies a call setting command (MakeCall) for a specific electronic apparatus with respect to the IP-PBX 307, in such a case that a functional component of this electronic component cannot be utilized, the IP-PBX 307 transfers the call setting command (MakeCall) to a secondary-designated functional component within a functional component group to which this unusable functional component belongs; and since this secondary-designated functional component issues a response, the IP-PBX 307 permits this functional component to establish a call setting operation with a counter functional component. Since such a transferring operation of the call setting command is carried out, a partial function of the central control unit 306 can be entrusted to both the IP-PBX 307 and also to the autonomous control of he functional component. Furthermore, the IP-PBX 307 may perform such a mixing process operation for a plurality of information acquired through a plurality of paths (as realized in electronic conference system) so as to produce new information. As previously described, while the central control unit 306 and the IP-PBX 307 are provided, the functions are shared by the central control unit 306 and the IP-PBX 307 by utilizing the call control operation, so that the reliability of the entire system can be improved, the control operation can be made simple, and further, the cost can be considerably lowered.

Next, a description is made of the electronic apparatus utilizing system in the case of the previously explained example. When a control unit 215_2 of the HDD recording/reproducing apparatus 110 installed on the second floor grasps such a fact that a picture recording request instruction is issued by an operation of the user, the control unit 215_2 notifies this situation change with respect to the central control unit 306. Upon receipt of the picture recording request instruction, the central control unit 306 judges that which functional component can be used based upon various sorts of information which have been registered and/or transmitted in/to the IP-PBX 307. The judging operation by the central control unit 306 is carried out in accordance with a previously set priority rule. In other words, the central control unit 306 makes the judgement in the below-mentioned manner: That is, for example, a top priority is given to a hard disk drive 201_1 of the HDD recording/reproducing apparatus 110 of the second floor on which the user tries to record picture data; in such a case that a remaining storage capacity of this hard disk drive 201_2 is empty, if there is a remaining storage capacity of a hard disk drive 201_1 of the HDD recording/reproducing apparatus 105 installed on the first floor, then the central control apparatus 306 judges that the hard disk drive 201_1 of the HDD recording/reproducing apparatus 105 installed on the first floor can be used.

If the hard disk drive 201_1 of the HDD recording/reproducing apparatus 105 installed on the first floor is used, the central control unit 306 performs an IP communication with respect to a control unit 215_1 of the HDD recording/reproducing apparatus 105, and turned ON a power supply of the power supply unit 225_1 so as to designate a tuner 204_2 of the HDD recording/reproducing apparatus 110 installed on the second floor and the hard disk drive 201_1 of the HDD recording/reproducing apparatus 105 installed on the first floor, and then, notifies a call setting command (MakeCall) to the IP-PBX 307. Upon receipt of he notification of the call setting command, the IP-PBX 307 transfers data between the tuner 204_2 and the hard disk drive 201_1, and transmits sound and picture signals tuned by the tuner 204_2 of the HDD recording/reproducing apparatus 110 installed on the second floor with respect to the hard disk drive 201_1 of the HDD recording/reproducing apparatus 105 installed on the first floor so as to record the sound and picture signals on this hard disk drive 201_1.

As a consequence, although the HDD recording/reproducing apparatus 105 installed on the down stairs and the HDD recording/reproducing apparatus 110 installed on the second floor correspond to physically separated electronic apparatuses, the electronic apparatus utilizing system of the embodiment 1 performs the control operation in such a manner that the functional components of the electronic apparatuses are connected to each other in a flexible manner as if these functional components were a single virtual electronic apparatus.

Moreover, in the electronic apparatus utilizing system of the embodiment 1, since the electric power from the power supply is conducted via the pole transformer 101 and the meter 102 into the above-described housing, even if the picture recording instruction issued from the control unit 215 to the central control unit 306 is leaked to the electric supplying line 103, this picture recording instruction is not leaked to a neighbor housing. As a result, the electronic apparatus utilizing system can be operated in a safety manner in view of security.

It should also be noted that since a control unit of each of the functional components (for example, control unit 215_2 of HDD recording/reproducing apparatus 110) corresponds to such a component having a function playing a certain role in a virtual electronic apparatus, it is possible that the control unit may be regarded as a functional component which is controlled by the central control unit 306. This reason is given as follows: That is, since the control unit 215_2 may be handled as one of functional components similar to other functional components from the central control unit 306, a control operation thereof may be simplified.

Also, since the refrigerator 112 is continuously turned ON for 24 hours, the central control unit 306 and the IP-PBX 307 have been provided in the refrigerator 112, and have be operated as the host unit of the network. Alternatively, central control unit, an IP-PBX, and the like may be provided in such a server which has been continuously turned ON for 24 hours.

In addition, a description is made of other electronic apparatuses. The television set 104 corresponding to one of the electronic apparatuses shown in FIG. 1 has such an arrangement as indicated in FIG. 4. The television set 104 is equipped with a large number of functional components as shown in FIG. 4. Concretely speaking, the television set 104 is provided with an antenna input module 401, a tuner 402, a display 403, an input module 404, an output module 405, and a communication buffer-purpose hard disk drive 406. The tuner 402 inputs thereinto information entered from the antenna input module 401. Moreover, the television set 104 is equipped with an IP communication stack 407, a PLC (Power Line Communication) modem 408, a power supply plug 409, and a control unit 410. The IP communication stack 407 corresponds to a software group in order to provide a network function. The PLC modem 408 corresponds to such an adaptor which feeds a data communication-purpose signal to the electric supplying line 103. The control unit 410 controls these structural components.

similar to the HDD recording/reproducing apparatus 105, also, in the television set 104, the control unit 410 holds an IP address of the television set 104 in a setting memory (not shown) of the IP communication unit 411. Even when a router, or the like has been installed in the home, since a communication operation is carried out based upon the IP address, the television 104 has been bright into such an information communicatable situation that the television set 104 can communicate information with respect to other electronic apparatuses provided within the home via the power supply plug 409. Further, the tuner 402 holds a functional component address thereof in an IP communication unit 412; the display 403 holds a functional component address thereof in an IP communication unit 413; the input module 404 holds a functional component address thereof in an IP communication unit 414, the output module 405 holds a functional component address thereof in an IP communication unit 415; and the communication buffer-purpose hard disk drive 406 holds a functional component address thereof in an IP communication unit 416. As previously explained, while the control unit 410 has held the IP address also in the television set 104, the respective functional components thereof have held the functional component addresses at the same time.

Also, the television set 104 is further equipped with a power supply unit 417. Then, if the power supply plug 409 has been connected to a power supply plug socket, then the control unit 410, the IP communication stack 407, and the PLC modem 408 have been operable due to stand-by power, even when the power supply of the power supply unit 417 is not turned ON. As a result, information can be communicated even among the IP communication stack 407, the PLC modem 408, the control unit 410, and other electronic apparatuses whose power supplies are not turned ON.

It should also be noted that while the television set 104 has been exemplified in the above example, another television set 109 installed on the second floor as shown in FIG. 1 has a similar structure to that of the first-mentioned television set 104. Accordingly, in such a case that the television set 109 is required to be discriminated from the television set 104 in the below-mentioned descriptions, either symbol “_1” or symbol “_2” will be properly given to a rear portion of a reference numeral, for instance, a “tuner 402_1” and then, a description will be made of the “tuner 402_1.” It should also be noted that when symbol “_1” is given to a rear portion of reference numeral of a functional component, this functional component corresponds to a functional component of the television set 104 installed on the first floor, whereas when symbol “_2” is given to a rear portion of reference numeral of a functional component, this functional component corresponds to a functional component of the television set 109 installed on the second floor.

Then, the television set 104 and the television set 109 can be utilized as functional components capable of causing the display “403_1” and the display “403_2” to display contents in addition to originally provided functions of television sets 104 and 109. When the HDD recording/reproducing apparatus 105 and the HDD recording/reproducing apparatus 110 perform reproducing operations, the television sets 104 and 109 display thereon reproduced contents. As such an example in the case that a recorded content of an HDD recording/reproducing apparatus is reproduced by a display of a television set, such a case that a functional component display is used will be described in detail in an embodiment 2 of the present invention. Also, a recorded content of one HDD recording/reproducing apparatus may be reproduced on a television set via a functional component output module of the other HDD recording/reproducing apparatus. It should also be understood that as to the functional components of the electronic apparatuses such as the HDD recording/reproducing apparatus, the refrigerator, and the television set, since it is required to utilize commonly-utilized sorts of functional components with each other, the same sort of functional components which are utilized with each other have been equipped with at lest a minimum number of functions having a substitution characteristic, and these functional components may be commonly utilized with each other.

Next, a description is made of such a case that in the above-described electronic apparatus utilizing system provided in the home, for instance, a certain television program “aaaaa” which has been recorded on either the HDD recording/reproducing apparatus 110 installed on the second floor or the HDD recording/reproducing apparatus 105 installed on the first floor is reproduced so as to be viewed by utilizing the television set 109 of the second floor.

When the user tries to view a recorded television program by using the television set 109 installed on the second floor, the user operates a remote control (not shown) of the HDD recording/reproducing apparatus 110 installed on the second floor in order to select a desirable television program. At this time, if the output module 206_2 of the HDD recording/reproducing apparatus 110 has been connected to the input module 404_2 of the television set 109 by employing a picture cable (not shown), then manipulations (for example, cursor movement etc.) of the remote controller is represented from the output module 206_2 of the HDD recording/reproducing apparatus 110 via the input module 404-2 of the television set 109 on the display 403_2. As a result, the user can manipulate the remote controller in an easy manner.

A program selecting request instruction made by the user is received by the control unit 215_2 via the remote input module 214_2. In response to the program selecting request instruction, the control unit 215_2 firstly tries to display a list of the recorded programs. However, if the programs have been recorded not on the HDD recording/reproducing apparatus 110 of the second floor, but recorded on the HDD recording/reproducing apparatus 105 of the down stair, then the control unit 215_2 of the HDD recording/reproducing apparatus 110 installed on the second floor executes the below-mentioned operations. That is, the control unit 215_2 firstly performs an IP communication with the central control unit 306 of the refrigerator 112 provided in the home so as to acquire information about programs recorded on the HDD recording/reproducing apparatus 105 installed on the first floor. Then, the control unit 215_2 outputs such a program information from the output module 206_2 toward the television set 109, while the program information has been formed by combining the program information recorded on the HDD recording/reproducing apparatus 110 installed on the second floor with the program information recorded on the HDD recording/reproducing apparatus 105 installed on the first floor. In other words, the control unit 215_2 provides the program information with respect to the user as if the provided program information were such programs recorded on the HDD recording/reproducing apparatus 110 installed on the second floor.

The user selects the target program “aaaaa” by viewing the program information indicated on the display 403_2 of the television 109. As a result, the program selecting request instruction of the user is received via the remote input module 214_2 by the control unit 215_2. The control unit 215_2 again performs an IP communication with the central control unit 306 of the refrigerator 112. Then, the central control unit 306 judges whether or not a functional component can be used based upon various sorts of information of a system setting unit, which have been registered and/or transmitted to the IP-PBX 307. In other words, in the example, the central control unit 306 judges whether or not the hard disk drive 201_1 of the HDD recording/reproducing apparatus 105 installed on the first floor can be used on which the television program “aaaaa” has been recorded based upon the stored situation information, namely, operation situations (under operation/stand-by situation/under notification of abnormal event).

Moreover, the central control unit 306 selects the display 403_2 of the television set 109 installed on the second floor as a functional component for receiving the sound and picture signals of the recorded program “aaaaa.” This selection of the display 403_2 of the television set 109 can be carried out by that the central control unit 306 has also contained connection information among the electronic components in the stored situation information. In other words since a present communication counter-party corresponds to the control unit 215_2 of the HOD recording/reproducing apparatus 110, the central control unit 306 defines the television set 109 of the second floor where the user is present and is now manipulating the television set 109 as a reproduction destination.

Next, the central control unit 306 performs an IP communication with the control unit 215_1 of the HDD recording/reproducing apparatus 105 installed on the first floor, and turns ON the power supply of the power supply unit 225_1 so as to designate both the hard disk drive 201_1 of the HDD recording/reproducing apparatus 105 installed on the first floor and the display 403-2 of the television set 109 installed on the second floor and to notify a call setting command (MakeCall) to the IP-PBX 307. Due to the function of the IP-PBX 307 which has received this call setting command (MakeCall), the IP-PBX 307 transfers data between the hard disk drive 201_1 and the display 403_2 so as to transmit the picture signal of the program “aaaaa” recorded on the hard disk drive 201_1 of the HDD recording/reproducing apparatus 105 installed on the first floor to the display 403_2 of the television receiver 109 installed on the second floor. Similarly, the IP-PBX 307 transmits a sound signal of the program “aaaaa” to a speaker (not shown) of the television 109 installed on the second floor, so that the IP-PBX 307 can cause the user to view the desirable program “aaaaa” by the television set 109.

As a consequence, although the HDD recording/reproducing apparatus 105 installed on the down stair and the HDD recording/reproducing apparatus 110 installed on the second floor, which is connected to the television set 109 by the picture cable, correspond to physically separated electronic apparatuses, the electronic apparatus utilizing system of the embodiment 1 performs the control operation in such a manner that the functional components of the electronic apparatuses are connected to each other in a flexible manner as if these functional components were a single virtual electronic apparatus.

Alternatively, a substance of an electronic apparatus system which constructs the previously described virtual electronic apparatus may be represented as, for instance, FIG. 5.

It should also be understood that the same reference numerals shown in FIG. 2 to FIG. 4 will be employed as those for denoting the same functional components indicated in FIG. 5, and therefore, duplicated explanations thereof will be omitted. Reference numeral 306 is the central control unit 306 of the refrigerator 112 described in FIG. 3. Reference numeral 307 is the IP-PBX 307 of the refrigerator 112. The IP-PBX 307 sub-divides collected members of virtual functional components into groups based upon the information about the sort of functional components registered by all the IP communication units (IP communication unit 216 etc.), and then, manages the groups of the virtual functional components. The management of the information is carried out by registering the information in the IP-PBX 307. It should also be noted that if such addresses containing logical identifiers are used as functional component addresses, then the collected members may be easily grouped.

A tuner unit group 501 corresponds to a virtual collected member such as a registered tuner 204_1 and other registered tuners. The tuner 204_1 corresponds to the tuner 204 of the HDD recording/reproducing apparatus 105 installed on the first floor, as explained in FIG. 2, whereas a tuner 204_2 corresponds to the tuner 204 of the HDD recording/reproducing apparatus 110 installed on the second floor. Similarly, a tuner 402_1 corresponds to the tuner 402 of the television set 104 installed on the first floor, as explained in FIG. 4. Since other tuners are similar to the electronic apparatuses, descriptions thereof will be omitted.

A hard disk drive unit group 502 corresponds to a virtual collected member such as a registered hard disk drive 201_1 and other registered hard disk drives. The hard disk drive 201_1 corresponds to the hard disk drive 201_1 of the HDD recording/reproducing apparatus 105 installed on the first floor, as explained in FIG. 2, whereas a hard disk drive 201_2 corresponds to the hard disk drive 201_2 of the HDD recording/reproducing apparatus 110 installed on the second floor.

As previously described, the IP-PBX 307 may manage the respective functional components of the respective electronic apparatuses as groups of virtual functional components irrespective to such a situation that these functional components are physically located at which positions of which apparatuses. Then, the IP-PBX 307 notifies information as to the managed groups to the central control unit 306. The central control unit 306 registers the notified information of the groups and the situation information to the system setting unit, and thus, executes various sorts of services based upon the registered group information and the registered situation information.

In such a case that a picture recording reservation is carried out, simultaneous utilizations of such functional components are permitted, the total number of which is equal to that of all the functional components connected to the IP-PBX 307. Since 6 sets of tuners (namely, tuners 204_1, 204_2, 205_1, 205_2 402_1, and 402_2) have been registered to the tuner unit group 501, in the electronic apparatus system which constitutes the relevant virtual electronic apparatus, the simultaneous utilization number of the tuners may be extended up to six in maximum, As a result, if the simultaneous utilization number does not exceed six, then a total number of programs to be recorded is not limited to a total number of tuners mounted on each of HDD recording/reproducing apparatuses.

As previously explained, since the user operates HDD recording/reproducing apparatuses via the central control unit 306, the user can have such a feeling that plural sets of HDD recording/reproducing apparatuses are virtually operated as a single set of HDD recording/reproducing apparatus without paying his specific attention to those plural HDD recording/reproducing apparatuses. That is, the user need not pay his attention to a limitation as to a total quantity of functional components mounted on each of electronic apparatuses. In other words, the user can perform picture recording operations via the central control unit 306 by utilizing all the tuners employed in such an electronic apparatus system which constructs a virtual electronic apparatus.

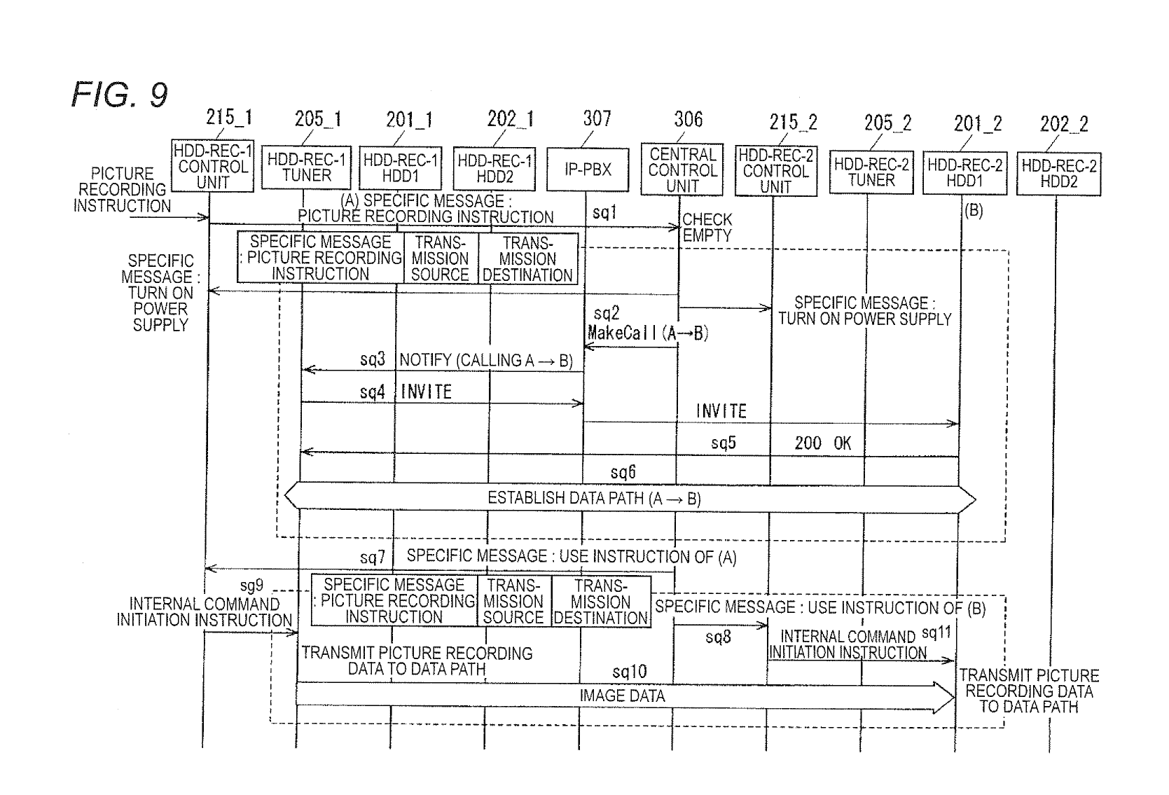

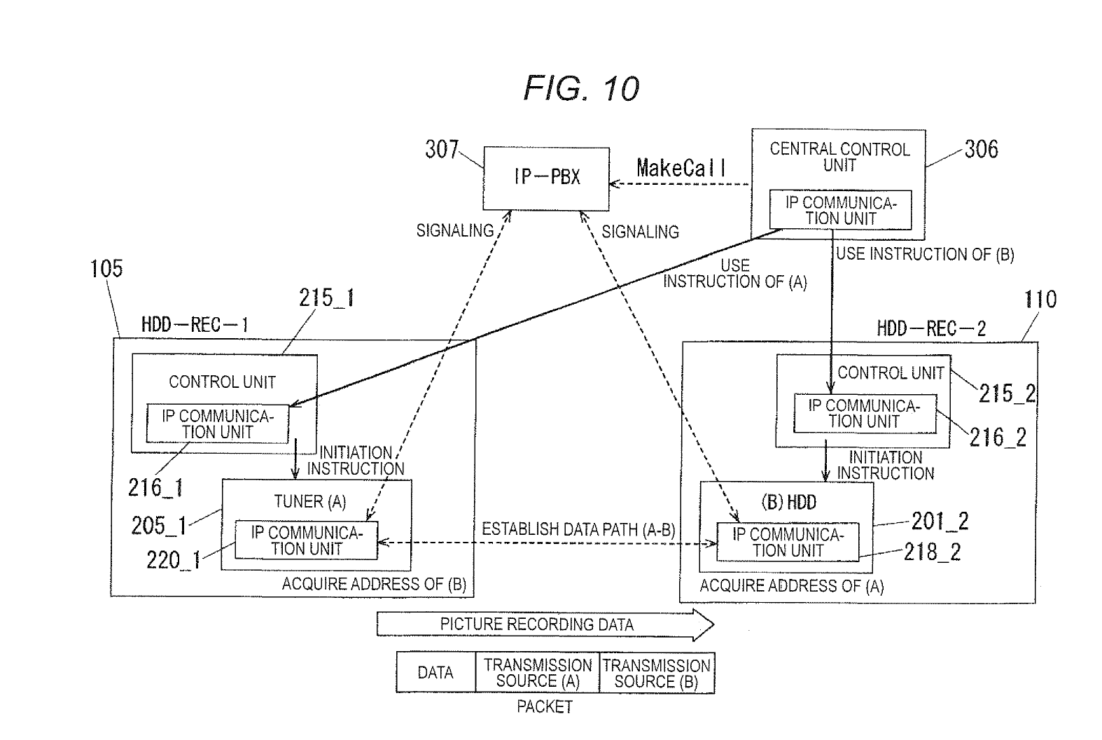

Referring now to FIG. 6 through FIG. 10, a description is made of operations as to the electronic apparatus system which constitutes the virtual electronic apparatuses of FIG. 5. FIG. 6 is an explanatory diagram for explaining data flows of the electronic apparatus system of FIG. 5. FIG. 7 is a diagram for representing use situations as to structural components of the electronic apparatus system shown in FIG. 5. FIG. 8 is a flow chart for describing operations of the electronic apparatus system indicated in FIG. 5. FIG. 9 is an explanatory diagram for explaining a control sequence executed in the electronic apparatus system. FIG. 10 is a diagram for representing data flows executed between electronic apparatuses in accordance with the control sequence of FIG. 9.

Firstly, a description is made that how members of a functional component group construct virtual electronic apparatuses with each other based upon which sequential operation. It should be noted that the below-mentioned control sequence will be explained based upon the SIP protocol. As represented in FIG. 6 and FIG. 9, when a picture recording instruction is issued by an operation of a user, the control unit 215_1 installed on the down stair notifies a picture recording instruction message to the central control unit 306 (“sq1”). As a result, the central control unit 306 checks an empty of functional components in order to judge whether or not which functional component can be used. The picture recording instruction message may be alternatively made by a specific message format. As a result of this checking operation, for instance, the central control unit 306 notifies such a message for turning power OFF-states to power ON-states as to both the tuner 205_1 (“A” in FIG. 9) of the members of the tuner Unit group 501 provided in the HDD recording/reproducing apparatus 105 installed on the down stair and the hard disk drive 201_2 (“B” in FIG. 9) of the members of the tuner unit group 502 provided in the HDD recording/reproducing apparatus 110 installed on the second floor in order to supply electric power thereto (this message may be alternatively made of specific message format). Also, the central control unit 306 designates a call setting operation (A→B) from this tuner 205_1 to the hard disk drive 201_2, and then, notifies a call setting command (MakeCall) (“sq2”). Upon receipt of this call setting command, the IP-PBX 307 transmits “NOTIFY (use notification)” corresponding to a calling command to the tuner 205_1 (“sq3”).

As previously explained, while the central control unit 306 may not especially designate a specific tuner 205_1, the central control unit 306 may alternatively designate the tuner unit group 501 so as to cause the tuner unit group 501 to perform a group call receiving operation in a batch mode, and to set a calling operation. In this alternative case, the central control unit 306 no longer judges the designation. Also, even when the central control unit 306 designates the specific tuner 205_1, in such a case that the designated tuner 205_1 is actually under operation, the central control unit 306 may alternatively transfer the tuners within the tuner unit group 501. In other words, while the judging operations are not made only by the central control unit 306, the judging operations may be distributed so as to select the relevant functional components.

A call control message 601 indicated in FIG. 6 corresponds to “NOTIFY” which is transmitted from the IP-PBX 307 to the tuner 205_1 of the members of the tuner unit group 501 in FIG. 9. The tuner 205_1 can grasp that, for example, a new communication counter party is the hard disk drive 201_2 of the members of the hard disk drive unit group 502 based upon the transmitted “NOTIFY”, and thus, can recognize an IP address thereof. At the same time, the tuner 205_1 receives an instruction for starting a P2P communication 603.

Upon receipt of “NOTIFY”, the tuner 205_1 transmits “INVITE” as a SETUP message to the hard disk drive 201_2 in order to establish a data path between the hard disk drive 201_2 and the own tuner 205_1 (“sq4”). A call control message 602 shown in FIG. 6 indicates that “INVITE” transmitted from the tuner 205_1 has been transferred from the IP-PBX 307 as shown in FIG. 9.

The hard disk drive 201_2 which has received “INVITE” transmitted from the IP-PBX 307 returns “200 OK” (“sq5”) Furthermore, an “ACK” is transmitted from the tuner 205-1, so that a data path (A-B) is established by “P2P” communication manner (“sq6”). As a result, the tuner 205_1 can be directly communicated with the hard disk drive 201_2 via the data path (A-B) as shown in FIG. 6 by the P2P communication manner.

When the data path (A-B) has been established between the tuner 205_1 and the hard disk drive 201_2, the central control unit 306 transmits a use instruction message capable of operating the tuner 205_1 to the control unit 215_1 of the HDD recording/reproducing apparatus 105 installed on the first floor (“sq7”). In connection with the transmission of the use instruction message, the central control unit 306 transmits a use instruction message capable of operating the hard disk drive 201_2 to the control unit 215_2 of the HDD recording/reproducing apparatus 110 installed on the second floor (“sq8”). Alternatively, the use instruction message may be constructed based upon a specific message format. Upon receipt of the use instruction message, the control unit 215_1 instructs the tuner 205_1 to be initiated by an internal command (sq9). As a result, the tuner 205_1 transmits such an IP packet that picture recording data is utilized as a payload to the data path (A-B), while the hard disk drive 201_2 is defined as a destination of the IP packet (sq10). Also, upon receipt of the use instruction message, the control unit 215_2 also instructs the hard disk drive 201_2 to be initiated by the internal command (sq11), and the hard disk drive 201_2 records thereon the received picture recording data.

Next, the signal flows will now be described as flows of signals after housings of electronic apparatuses have been reflected. FIG. 10 shows flows of signals among four electronic apparatuses, namely, the central control unit 306, the IP-PBX 307, the HDD recording/reproducing apparatus 105, and the HDD recording/reproducing apparatus 110. In FIG. 10, lines written by broken lines indicate flows of signals based upon call control (SIP in this example). When a picture recording instruction is issued, it is so indicated that the central control unit 306 transmits a call setting command (“MakeCall”) to the IP-PBX 307, and connects the tuner 205_1 of the HDD recording/reproducing apparatus 105 to the hard disk drive 201_2 of the HDD recording/reproducing apparatus 110 so as to perform a P2P communication.

In contrast to the signal flows written by the broken lines, signal flows written by solid lines in FIG. 10 correspond to flows of control signals when the central control unit 306 initiates virtual electronic apparatuses. When the central control unit 306 makes such a judgement to construct a virtual HDD recording/reproducing apparatus by employing a combination of the tuner 205_1 and the hard disk drive 201_2 based upon information about groups of functional components and situation information thereof, the central control unit 306 transmits an instruction for turning ON a power supply, and also, a use instruction of the tuner 205_1 to the control unit 215_1 of the HDD recording/reproducing apparatus 105. Also, the central control unit 306 transmits an instruction for turning ON a power supply, and also, a use instruction of the hard disk drive 201_2 to the control unit 215_2 of the HDD recording/reproducing apparatus 110. Upon receipt of the use instruction, the control unit 215_1 turns ON the power supply of the power supply unit 225-1 so as to operate the tuner 205_1, and the control unit 215_2 turns ON the power supply of the power supply unit 225_2 so as to operate the hard disk drive 201_2. When the data path (A-B) has been established, the tuner 205_1 transmits such an IP packet that picture recording data is utilized as a payload thereof by using the established data path (A-B). The hard disk drive 201_2 derives the picture recording data from the IP packet so as to record the derived picture recording data.

As previously described, in the embodiment 1, a data path is established between functional components namely, (tuner 205_1 and hard disk drive 201_2) which constitute a virtual HDD recording/reproducing apparatus based upon a call control using the IP-PBX 307, and then, a data transferring operation is carried out between the functional components by using the established data path. As a consequence, even in such a case that an electronic apparatus (namely, HDD recording/reproducing apparatus 110) cannot be used which is wanted to be operated by the user, the central control unit 306 combines the functional components of the electronic apparatus with each other so as to construct a single virtual electronic apparatus, and thus, the central control unit 306 can realize such a utilization which can satisfy the requirement by the user in appearance. It should also be noted that concrete operations will be again explained later even in the below-mentioned flow chart of FIG. 8.

In FIG. 7, reference numeral 701 is information indicative of a picture recording execution situation based upon a picture recording reservation in the system setting unit. The picture recording execution situation represents that while recording operations of four television programs such as “bbbbb” have been reserved a picture recording operation is commenced since a television program broadcasting time has reached. Reference numerals 702 is information indicative of present use situations of the respective functional components. The above-described sorts of information have been managed by the central control unit 306 in the system setting unit based upon situation information which has been properly received by the IP-PBX 307, and have been held by the central control unit 306 as commonly used information of the electronic apparatus system. In the picture recording execution situation 701, reference numeral 703 shows that recording operations of three television programs (“bbbbb”, “ccccc”, “ddddd” etc.) are commenced. Then, reference numeral 704 indicates that a recording operation as to a fourth-reserved television program “aaaaa” is under preparation situation. In an actual case, since the recording preparation operations of four television programs are instantaneously carried out, the recording operations are commenced at the substantially same time.

In the use situation 702 of the respective functional components, information 705 to 708 indicate a use situation of a present tuner, and a remaining storage capacity of a present hard disk drive (for the sake of easy explanation, information 705 to 708 show physical positional relationship which can be understood). The use situation 702 indicates such a situation that three tuners indicated by the information 705 have been operated by recording the three television programs such as “bbbbb”, whereas a tuner indicated by the information can be used. In this example, the tuner of the information 706 corresponds to the tuner 205_1 of the HDD recording/reproducing apparatus 105 installed on the first floor. Similarly, the use situation 702 indicates that a remaining storage capacity of the hard disk drive indicated by the information 707 is 1 hour, and a remaining storage capacity of the hard disk drive indicated by the information 708 is 5.5 hours.

In the electronic apparatus system which constitutes the virtual electronic apparatus, the tuner 205_1 corresponds to the member of the tuner unit group 501. As a consequence if the tuner 205_1 is hot operated by another electronic apparatus, then this tuner 205_1 can be freely used by any other electronic apparatus. In other words, even when the user has reserved the picture recording operation by utilizing the HDD recording/reproducing apparatus 110 installed on the second floor, the picture recording operation can be carried out by operating the tuner 205_1 which is located at the physically different floor from the second floor under control of the central control unit 306. Then, when the tuner 205_1 can be electrically secured, the central control unit 306 updates the information 706 as under operation “Tuner 2: Used (Prog. 504).” When the tuner 205_1 is reserved, the information 706 is updated as 709 “Reserved (Prog. 504)”, and when the tuner 205_1 has been electrically secured, this information 706 is updated as 710 “Tuner 2: Used (Prog. 504).”

When a picture recording operation is commenced, there are some possibilities that a user is separately operating another tuner, and a remaining storage capacity of a hard disk drive has been increased, or decreased, since the user has deleted the picture recorded content. As a consequence, in the embodiment 1, even if a tuner has already been secured at a picture recording reservation, when a picture recording time has reached and thus a picture recording operation is commenced, the central control unit 306 again checks an empty storage capacity of the tuner and a remaining storage capacity of a hard disk drive. That is to say, in such a case that a recording operation execution time for the television program “aaaaa” has reached and then a picture recording operation is carried out, the central control unit 306 executes a picture recording execution process shown in FIG. 8.

A description is made of concrete operations based upon a flow chart shown in FIG. 8. In FIG. 8, the central control unit 306 which has received a picture recording request when a picture recording reservation time has reached judges conditions such as situations of the respective functional components, since a tuner function and a picture recording-purpose hard disk drive function are required as a function for a picture recording operation.

First of all, the central control unit 306 retrieves a usable member from the members of the tuner unit group 501 (step 801). The central control unit 306 judges the usable member based upon the use situations of the respective functional components shown in FIG. 7. The reason why such a judgement is required is given as follows: That is, if the user has separately operated a tuner, then the central control unit 306 has changed the use situation 702. Apparently, if a reserved tuner is available, then the central control unit 306 uses this reserved tuner with a top priority. At this time, the information 706 of the use situation 702 has been managed as under reservation “Tuner 2: Reserved (Prog. 504).”

Assuming now that the presently available functional component is the tuner 205_1 of the HDD recording/reproducing apparatus 105 installed on the first floor, the central control unit 305 updates the information 706 of the use situation 702 as under operation “Tuner 2: Used (Prog. 504).” Then, the central control unit 306 performs an IP communication with the control unit 215_1 of the HDD recording/reproducing apparatus 105 installed on the first floor, which is equipped with the tuner 205_1 as the functional component, so as to turn ON the power supply of the power supply unit 225_1 (step 802).

Next, the central control unit 306 retrieves a usable member from the members of the hard disk drive unit group 502 (step 803). The central control unit 306 judges the usable member based upon the use situations 702 of the respective functional components shown in FIG. 7.

Since the remaining storage capacity of the hard disk drive of the information 708 is 5.5 hours, the central control unit 306 judges that the usable member is the hard disk drive 201_2 of the HDD recording/reproducing apparatus 110 installed on the second floor based upon the present picture recording situation and the empty storage capacity. Then, the central control unit 306 performs an IP communication with the control unit 215_2 of the HDD recording/reproducing apparatus 110 installed on the second floor, which is equipped with the hard disk drive 201_2 as the functional component, so as to turn ON the power supply of the power supply unit 225_2 (step 804).

Next, in response to an instruction of the central control unit 306, since the IP-PBX 307 transmits “NOTIFY” explained in FIG. 9, and the tuner 205_1 transmits “INVITE” (call control messages 601 and 602), the IP-PBX 307 gives such an instruction that the tuner 205_1 is connected to the hard disk drive 201_2 by the P2P (Peer to Peer) communication manner. As a result, the tuner 205_1 is connected to the hard disk drive 201_2 by the P2P manner so as to establish a communication path (step 805).

Subsequently, if the central control unit 306 transmits a use instruction message to both the control unit 215_1 of the HDD recording/reproducing apparatus 105 installed on the first floor, and the control unit 215_2 of the HDD recording/reproducing apparatus 110 installed on the second floor, then the tuner 205_1 transmits the picture data of the television program “aaaaa” to the hard disk 201_2 by the P2P communication so as to store the picture data in this hard disk drive 201_2. As a consequence, a picture recording process is commenced in the virtual electronic apparatuses irrespective of the housing of the electronic apparatuses, namely, between the functional components (step 806).

Next, the central control unit 306 judges whether or not the picture recording process is accomplished (step 807). The judgement by the central control unit 306 is performed by checking whether or not an end time has reached which was designated when the picture recording reservation was made.

When the picture recording process is accomplished, in response to an instruction issued from the central control unit 306, the IP-PBX 307 gives such an instruction to the tuner 205_1 and the hard disk drive 201_2 that the P2P communication is cut off based upon the call control messages 601 and 602. As a result, one unit of the tuner 205_1 and the hard disk drive 201_2 transmits “BYE”, and the other unit transmits “200 OK” in order to cut off the P2P communication (step 808).

The central control unit 306 performs an IP communication with respect to both the control unit 215_1 of the HDD recording/reproducing apparatus 105 installed on the first floor and the central unit 215_2 of the HDD recording/reproducing apparatus 110 installed on the second floor in order to turn OFF the power supplies of the power supply unit 225_1 and the power supply unit 225_2 (step 809).

If there is no usable functional component in the above-described steps 801 and 804, then the picture recording process is accomplished as “picture recording operation fails.” Also, in the above-described step 807, in such a case that the functional component must be released before the requirements for completing the picture recording operation are satisfied (for instance, another reservation time with priority has reached), the P2P communication is cut off (step 810), and the functional component is released (step 811).

With execution of the above-described process operations, the picture recording process is accomplished in the virtual electronic apparatuses irrespective of the housings of the electronic apparatuses, namely, between the functional components. As previously explained, in accordance with the embodiment 1, even when the use situations of the functional components are unbalanced, 4 sorts of the television programs can be reserved and recorded at the same time irrespective of the housings of the HDD recording/reproducing apparatuses.

Also, since the instantaneous characteristic is not required but also the amounts of data to be transmitted/received are huge in communications of image data by employing the IP protocol, the communication buffer-purpose hard disk drives 202 have been set in the HDD recording/reproducing apparatuses 105 and 110. When a large amount of information is communicated by utilizing a communication buffer, congestion of network traffics can be suppressed.

As previously described, in the embodiment 1, the data path is established between the functional components (for example, between tuner 205_1 and hard disk drive 201_2) which construct the virtual HDD recording/reproducing apparatus based upon the call control by using the IP-PBX 307, and then, the data transfer operation is carried out between the functional components by using the established data path. As a consequence, even in such a case that an electronic apparatus (namely, HDD recording/reproducing apparatus 105) cannot be directly used which is originally wanted to be operated by the user, the central control unit 306 combines the functional components of the electronic apparatus with each other so as to construct a single virtual electronic apparatus, and thus, the central control unit 306 can realize such a utilization which can satisfy the requirement made by the user in appearance. Thus, the user may be brought into such a utilization environment that the user need not at all pay his attention to such a technical aspect that the picture data has been actually recorded on any one of the HDD recording/reproducing apparatuses 105 and 110.

### Embodiment 2

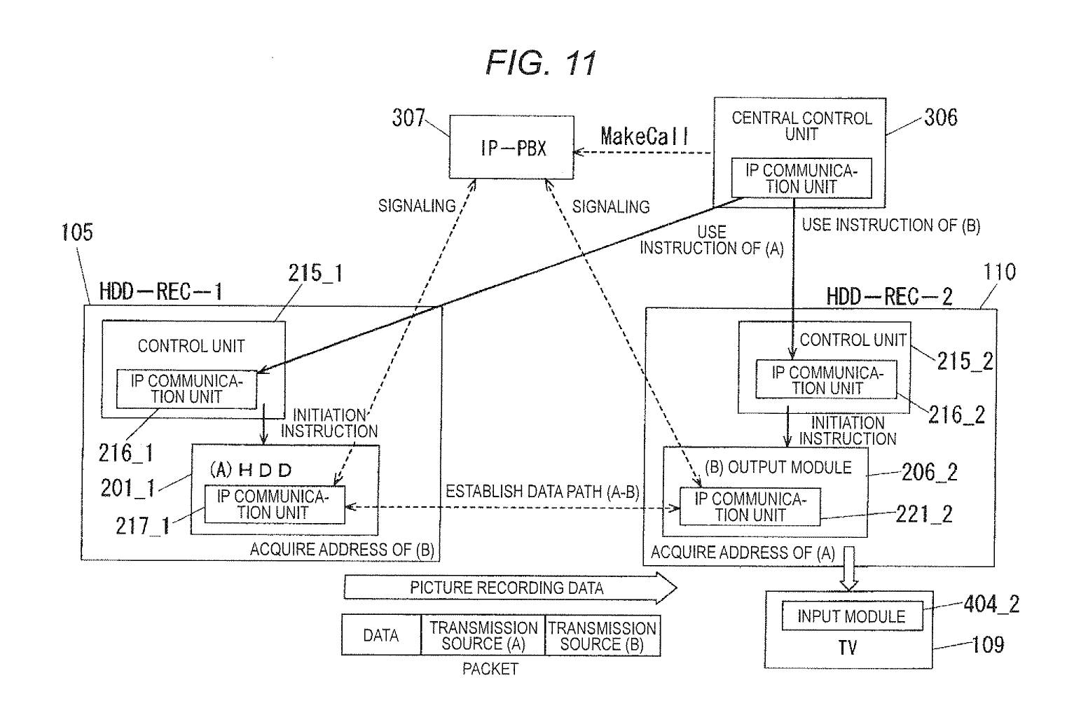

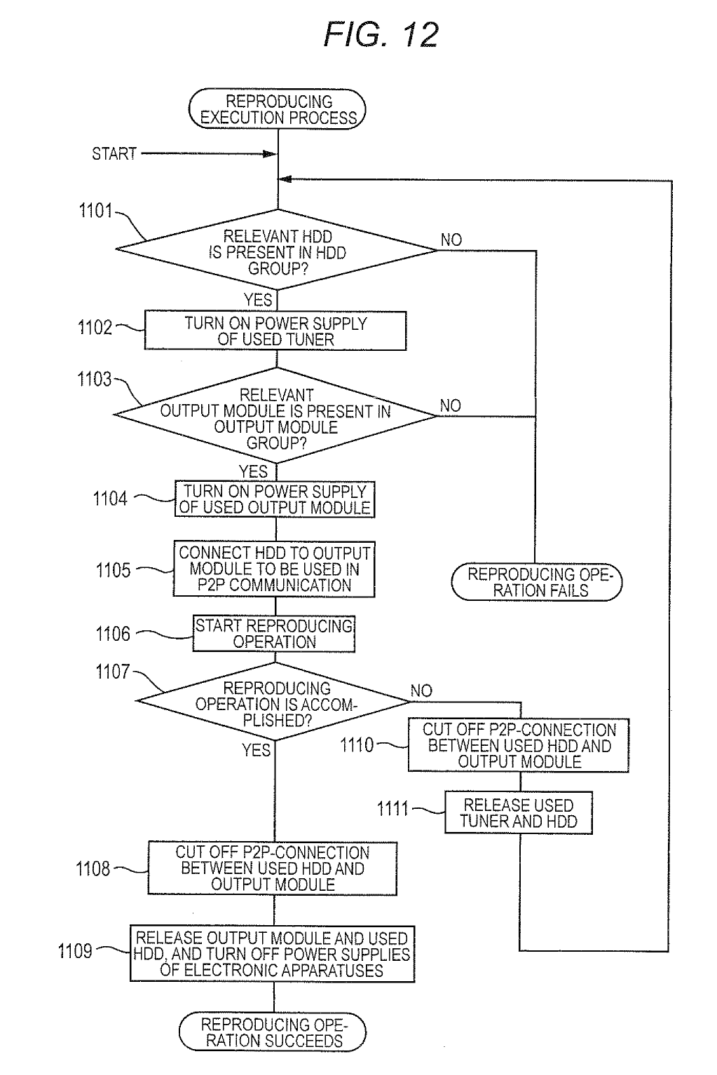

Referring now to FIG. 11 and FIG. 12, a description is made of an electronic apparatus and an electronic apparatus utilizing system using the electronic apparatus, according to an embodiment 2 of the present invention. FIG. 11 is a diagram for explaining data flows between the electronic apparatuses of the electronic apparatus system according to the embodiment 2 of the present invention. FIG. 12 is a flow chart for describing operations of the electronic apparatus system of FIG. 11. Since structural components of the electronic apparatuses according to the embodiment 2 are partially different from those of the embodiment 1, the same reference numerals will be employed as those for denoting the same functional components with reference to FIG. 1 to FIG. 10. Since control sequences executed among a central control unit, an IP-PBX, and functional components are basically similar to those of FIG. 9, detailed explanations thereof may be substituted by those of the embodiment 1.

An entire structure of the electronic apparatus utilizing system of the embodiment 2 is similar to that of the electronic apparatus utilizing system of FIG. 1. As indicated in FIG. 1, an HDD recording/reproducing apparatus 105 is installed on the first floor, whereas an HDD recording/reproducing apparatus 110 and a television set 109 are provided on the second floor, so that a network within a home is constructed. An input module 404_2 of the television set 109 is connected to an output module 206_2 of the HDD recording/reproducing apparatus 110 by employing a picture cable (not shown). Then, the embodiment 2 corresponds to such an electronic apparatus utilizing system that picture data recorded on a hard disk drive 201_1 of the HDD recording/reproducing apparatus 105 installed on the first floor is viewed on the television set 109 connected to the output module 206_2 of the HDD recording/reproducing apparatus 110 installed on the second floor. As a consequence, it is so understandable that functional components which construct a virtual HDD recording/reproducing apparatus correspond to the hard disk drive 201_1 and the output module 206_2.

Although the embodiment 1 has exemplified such a case that a recorded content of an HDD recording/reproducing apparatus has been reproduced by operating a television set, the embodiment 2 will exemplify in detail such an example that connection information between electronic components is no longer required.

Next, in FIG. 1, for instance, the below-mentioned case will be described: That is, a user reproduces a certain television program “aaaaa” recorded on either the HDD recording/reproducing apparatus 110 of the second floor or the HDD recording/reproducing apparatus 105 of the down stair, and then, views the reproduced television program “aaaaa” by operating the television set 109 installed on the second floor.

As represented in FIG. 1 and FIG. 4, when the user tries to view a recorded television program by using the television set 109 installed on the second floor, the user operates a remote controller (not shown) of the HDD recording/reproducing apparatus 110 installed on the second floor in order to select a desirable television program. At this time, since the output module 206_2 of the HDD recording/reproducing apparatus 110 has been connected to the input module 404_2 of the television set 109 by employing the picture cable (not shown), then manipulations (for example, cursor movement etc.) of the remote controller by the user is represented from the output module 206_2 of the HDD recording/reproducing apparatus 110 via the input module 404_2 of the television set 109 on the display 403_2. As a result the user can manipulate the remote controller in an easy manner.

A program selection request instruction made by the user is received by the control unit 215_2 via the remote input module 214_2. In response to the program selection request instruction, the control unit 215_2 firstly tries to display a list of the recorded programs. However, if the programs have been recorded not on the HDD recording/reproducing apparatus 110 of the second floor, but recorded on the HDD recording/reproducing apparatus 105 of the down stair, then the control unit 215_2 of the HDD recording/reproducing apparatus 110 installed on the second floor executes the below-mentioned operations.

That is, the control unit 215_2 firstly performs an IP communication with the central control unit 306 of the refrigerator 112 provided in the home so as to acquire information about programs recorded on the HDD recording/reproducing apparatus 105 installed on the first floor, while the program information has been derived from information of the system setting unit under management by the central control unit 306. Then, the control unit 306 outputs the acquired program information from the output module 206_2 to the television set 109. The control unit 215_2 may provide all the program information with respect to the user as if all the program information were such programs recorded on the HDD recording/reproducing apparatus 110 of the second floor. It should also be noted that the control unit 215_2 may alternatively acquire the program information recorded from the central control unit 306 on the HDD recording/reproducing apparatus 110 of the down stair, and may alternatively unify the program information recorded on the HDD recording/reproducing apparatus 110 of the second floor with the program information recorded on the HDD recording/reproducing apparatus 105 of the down stair in the own system setting unit, and thereafter, may alternatively output the unified program information from the output module 206_2 to the television set 109.

The user selects the target program “aaaaa” by viewing the program information indicated on the display 403_2 of the television 109. As a result, the program selection instruction of the user is received via the remote input module 214_2 by the control unit 215_2. The control unit 215_2 again performs an IP communication with the central control unit 306 of the refrigerator 112. Then, the central control unit 306 judges whether or not a functional component can be used based upon various sorts of information of a system setting unit which have been registered and/or transmitted to the IP-PBX 307. In other words, in the example, the central control unit 306 judges whether or not the hard disk drive 201_1 of the HDD recording/reproducing apparatus 105 installed on the first floor can be used on which the television program “aaaaa” has been recorded based upon the stored situation information, namely, operation situations of the respective functional components (under operation/stand-by situation/under notification of abnormal event).

Moreover, the central control unit 306 selects the output module 206_2 of the HDD recording/reproducing apparatus 110 installed on the second floor as a functional component for receiving the sound and picture signals of the recording program “aaaaa.” This output module selection can be carried out by selecting such a functional component with a top priority, which is under control of the control unit 215_2 of the HDD recording/reproducing apparatus 110 of the second floor, which corresponds to the present communication counter party. In other words, since the present communication counter party corresponds to the control unit 215_2 of the HDD recording/reproducing apparatus 110 installed on the second floor, the central control unit 306 transmits the sound and picture signals of the program “aaaaa” to the output module 206_2 of the HDD recording/reproducing apparatus 110 of the second floor where the user who is now manipulating this HDD recording/reproducing apparatus 110 is present. As a result, the central control unit 306 reproduces the recorded program on the television 109 of the second floor which has been connected to the output module 206_2 via the picture cable.

Next, the central control unit 306 performs an IP communication with the control unit 215_1 of the HDD recording/reproducing apparatus 105 installed on the first floor, and turns ON the power supply of the power supply unit 225_1 thereof, and also, the central control unit 306 executes an IP communication with the control unit 215_2 of the HDD recording/reproducing apparatus 110 installed on the second floor, and turns ON the power supply of the power supply unit 225_2 thereof so as to initiate the respective HDD recording/reproducing apparatuses 105 and 110. Then, the central control unit 306 designates the hard disk drive 201_1 of the HDD recording/reproducing apparatus 105 installed on the first floor, and the output module 206_2 of the HDD recording/reproducing apparatus 110 installed on the second floor, and notifies a call setting command (MakeCall) to the IP-PBX 307. Due to the function as to an IP switching apparatus executed by the IP-PBX 307 which has received this call setting command (MakeCall), the IP-PBX 307 transfers data between the hard disk drive 201_1 and the output module 206_2; and transmits the sound and picture signals of the program “aaaaa” recorded on the hard disk drive 201_1 of the HDD recording/reproducing apparatus 105 installed on the first floor to the output module 206_2 of the HDD recording/reproducing apparatus 110 installed on the second floor. The IP-PBX 307 supplies the sound and picture signals via the input module 404_2 connected to the output module 206_2 via the picture cable, by which the user can view the program on the television set 109.

As a consequence, although the HDD recording/reproducing apparatus 105 installed on the down stair and the HDD recording/reproducing apparatus 110 installed on the second floor, which is connected to the television set 109 by the picture cable, correspond to physically separated electronic apparatuses, the electronic apparatus utilizing system of the embodiment 2 performs the control operation in such a manner that the functional components of the electronic apparatuses are connected to each other in a flexible manner as if these functional components were a single virtual electronic apparatus.

FIG. 11 shows flows of data among four electronic apparatuses, namely, the central control unit 306, the IP-PBX 307, the HDD recording/reproducing apparatus 105, and the HDD recording/reproducing apparatus 110. Basically, the data flows of FIG. 11 are similar to those of FIG. 10. Referring now to FIG. 11, the signal flows will now be described as flows of signals after housings of electronic apparatuses have been reflected. In FIG. 11, broken lines indicate flows of signals based upon a call control (SIP in this example). When a program selecting instruction is issued, the central control unit 306 transmits a call setting command (“MakeCall”) to the IP-PBX 307, and thus, the IP-PBX 307 connects the hard disk drive 201_1 of the HDD recording/reproducing apparatus 105 to the output module 206_2 of the HDD recording/reproducing apparatus 110 so as to perform a P2P communication by establish a data path.

In contrast to the signal flows written by the broken lines, signal flows written by solid lines in FIG. 11 correspond to flows of control signals when the central control unit 306 initiates virtual electronic apparatuses. When the central control unit 306 constructs a virtual HDD recording/reproducing apparatus by employing a combination of the output module 206_2 and the hard disk drive 201_1, the central control unit 306 transmits an instruction for turning ON a power supply to the control unit 215_1 of the HDD recording/reproducing apparatus 105. Also, the central control unit 306 transmits a use instruction of the hard disk drive 201_1 to the control unit 215_1. Further, the central control unit 306 transmits an instruction for turning ON a power supply, and also, a use instruction of the output module 206_2 to the control unit 215_2 of the HDD recording/reproducing apparatus 110. Upon receipt of the use instruction, the control unit 215_1 turns ON the power supply of the power supply unit 225_1 so as to initiate the hard disk drive 201_1, and the control unit 215_2 turns ON the power supply of the power supply unit 225_2 so as to initiate the output module 206_2. When the data path has been established, the hard disk drive 201_1 transmits from the IP communication unit 220_1 such an IP packet that picture recording data is utilized as a payload thereof by using the established data path to the output module 206_2. The output module 206_2 derives the picture recording data from the IP packet, and transmits the derived picture recording data to the input module 404_2 of the television set 109 connected to the output module 206_2 by the picture cable, so that the picture recording data can be represented on the display 403_2.

Subsequently, a description is made of sequential operations for reproducing picture recorded contents based upon a flow chart of FIG. 12. The central control unit 306 which has received a recorded picture reproducing request retrieves such a member which has held picture recording data from the members of the hard disk drive group 502 (step 1101). This member becomes the hard disk drive 201_1. If such a member is not present, then the picture reproducing operation fails.

Next, the central control unit 306 updates information as to use situations of the hard disk drive 201_1 as “under operation.” Then, the central control unit 306 performs an IP communication with the control unit 215_1 of the HDD recording/reproducing apparatus 105 installed on the first floor which is equipped with the hard disk drive unit 201_1 as the functional component so as to turn ON the power supply of the power supply unit 225_1 (step 1102).

Next, the central control unit 306 retrieves the output module 206_2 of the HDD recording/reproducing apparatus 110 connected to the television set 109 from the members of the output module group based upon the use situations of the respective functional components (step 1103).

Next, the central control unit 306 performs an IP communication with the control unit 215_2 of the HDD recording/reproducing apparatus 110 installed on the second floor which is equipped with the output module 206_2 as the functional component so as to turn ON the power supply of the power supply unit 225_2 (step 1104).

Next, in response to an instruction of the central control unit 306, based upon “INVITE” and “NOTIFY” as explained in FIG. 9, the IP-PBX 307 gives such an instruction that the output module 206_2 is connected to the hard disk drive 201_1 by the P2P (Peer to Peer) communication manner. As a result, the output module 206_2 is connected to the hard disk drive 201_1 by the P2P communication manner so as to establish a communication path (step 1105).

Subsequently, if the central control unit 306 transmits a use instruction message to both the control unit 215_1 of the HDD recording/reproducing apparatus 105 installed on the first floor, and the control unit 215_2 of the HDD recording/reproducing apparatus 110 installed on the second floor, then the hard disk drive 201_1 transmits the picture data recorded thereon to the output module 206_2 by the P2P communication so as to reproduce the recorded picture data on the display 403_2 via the picture cable and the input module 404_2 of the television set 109 (step 1106).

Next, the central control unit 306 judges whether or not the picture reproducing process is accomplished (step 1107).

When the picture reproducing process is accomplished, in response to an instruction issued from the central control unit 306, the IP-PBX 307 gives such an instruction to the output module 206_2 and the hard disk drive 201_1 that the P2P communication is cut off based upon a call control message. As a result, one unit of the output module 206_2 and the hard disk drive 201_1 transmits “BYE”, and the other unit transmits “200 OK” in order to cut off the P2P communication (step 1108).

The central control unit 306 performs an IP communication with respect to both the control unit 215_1 of the HDD recording/reproducing apparatus 105 installed on the first floor and the control unit 215_2 of the HDD recording/reproducing apparatus 110 installed on the second floor in order to turn OFF the power supplies of the power supply unit 225_1 and the power supply unit 225_2 (step 1109).

If there is no relevant functional component in the above-described steps 1101 and 1104, then the picture reproducing process is accomplished as “picture reproducing operation fails.” Also, in the above-described step 1107, in such a case that the functional component must be released before the requirements for completing the picture reproducing operation are satisfied, the P2P communication is cut off (step 1110), and the functional component is released (step 1111).

As previously described, in this embodiment 2, the data path is established between the functional components (for example, between output module 206_2 and had disk drive 201_1) which construct a virtual HDD recording/reproducing apparatus based upon the call control by using the IP-PBX 307, and also, the data transfer operation is carried out between the functional components by using the established data path. As a consequence, even when the picture data has not been recorded on the HDD recording/reproducing apparatus 105 connected to the television 109, which is wanted to be operated by the user, the central control unit 306 combines the functional components (namely, hard disk drive 201_1 and output module 206_2) with each other so as to construct a single virtual electronic apparatus, and thus, the user can view the reproduced desirable picture data without performing a specific manipulation.

Then, the user completely need not consider the combination between the HDD recording/reproducing apparatuses 105, 110, and the television sets 104, 109. When such a television program recorded on the HDD recording/reproducing apparatus 105 installed on the first floor is wanted to be viewed by the user, even if any one of his families has operated the television set 104 which is physically connected to this HDD recording/reproducing apparatus 105 by employing the picture cable, if the television set 109 of the second floor is not under operation, the user can view the recorded television program. This reason is given as follows: That is, while the central control unit 306 connects the hard disk drive 201_1 of the HDD recording/reproducing apparatus 105 installed on the first floor to the output module 206_2 of the HDD recording/reproducing apparatus 110 in the P2P communication manner, the central control unit 306 transmits the picture data from the HDD recording/reproducing apparatus 105 of the first floor via the output module 206_2 of the HDD recording/reproducing apparatus 110 of the second floor to the television 109 so as to display the contents of the transmitted picture data on the display 403_2. As previously explained, even when the television set 104 is under operation which is connected to the HDD recording/reproducing apparatus 105 of the first floor, the user can view such a recorded television program in a layout free manner by operating another television set.

Also, as explained in this embodiment 2, since the picture data can be transmitted to the television set 109 via the output module 206_2 of the HDD recording/reproducing apparatus 110 of the second floor, even in such a case that the television set 109 installed on the second floor is a general-purpose television set, the user can view the recorded television program in the layout free.

### Embodiment Mode 3

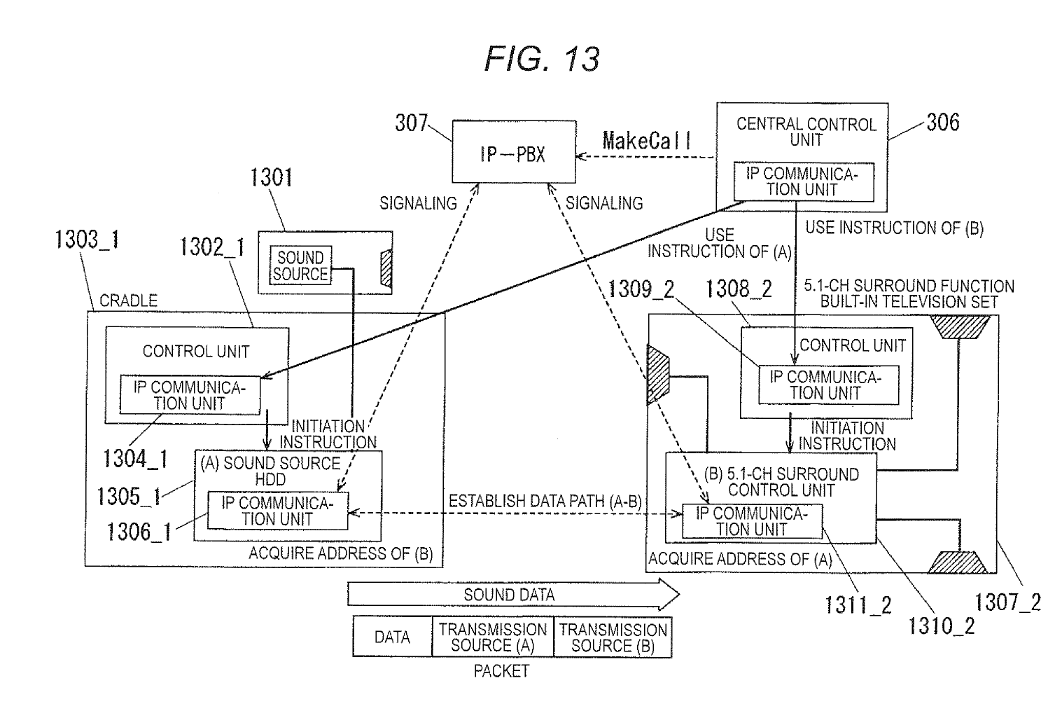

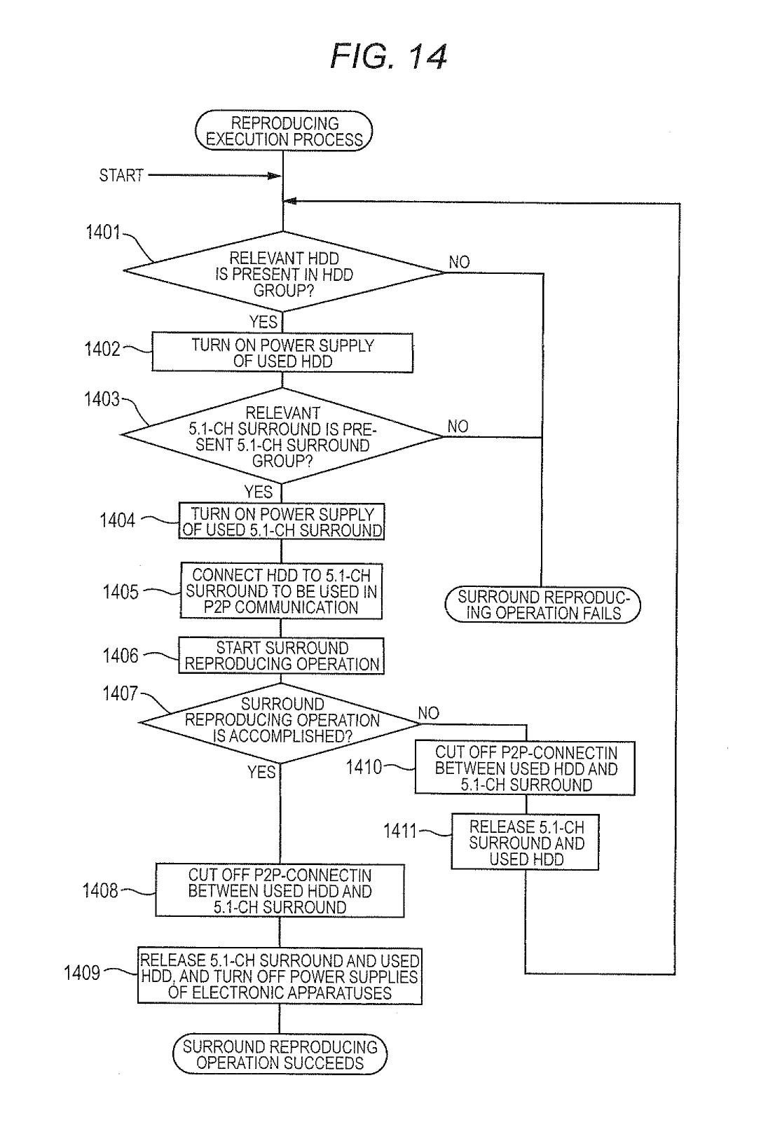

Referring now to FIG. 13, a description is made of an electronic apparatus and an electronic apparatus utilizing system using the electronic apparatus, according to an embodiment 3 of the present invention. The electronic apparatus utilizing system corresponds to such an electronic apparatus utilizing system which constitutes a 5.1-ch (channel) surround system. FIG. 13 is a diagram for explaining data flows between the electronic apparatuses of the electronic apparatus system according to the embodiment 3 of the present invention. FIG. 14 is a flow chart for describing operations of the electronic apparatus system of FIG. 13. Since structural components of the electronic apparatuses according to the embodiment 3 are merely different from those of the embodiment 1, a description is made of the electronic apparatus utilizing system of the embodiment 3 with reference to FIG. 1 to FIG. 8. Since control sequences executed among a central control unit, an IP-PBX, and functional components are basically similar to those of FIG. 9, detailed explanations thereof may be substituted by those of the embodiment 1.

An entire structure of the electronic apparatus utilizing system of the embodiment 3 is similar to that of the electronic apparatus utilizing system of FIG. 1. Although not indicated in FIG. 1, a cradle 1302_1 for mounting thereon a music player 1301_1 as shown in FIG. 13 is provided on the first floor. The cradle 1302_1 is to mount thereon the music player 1301_1 and is connected to a network within a home, so that the cradle 1302_1 can send out music data to the network.

In the embodiment 3, as the television set 109 of the second floor, which is shown in FIG. 1, such a 5.1-ch surround built-in television 1307_2 as represented in FIG. 13 is provided. Also, although not shown in FIG. 1, the cradle 1302_1 is installed on the first floor, the music player 1301_1 is mounted on this cradle 1302_1, and these functional components are connected to the power supply and are connected in such a manner that information can be communicated to an outdoor network.

In other words, the electronic apparatus utilizing system of the embodiment 3 corresponds to such a system that sound source data of the music player 1301_1 installed on the first floor is heard by utilizing the 5.1-ch surround built-in television set 1307_2 installed on the second floor. As a consequence, functional components which constitute a virtual 5.1-ch surround system correspond to a sound source hard disk drive 1305_1 of the cradle 1302_1, and a 5.1-ch surround control unit 1310_2 of the 5.1-ch surround built-in television 1307_2.

FIG. 13 shows flows of data among four electronic apparatuses, namely, the central control unit 306, the IP-PBX 307, the cradle 1302_1, and the television set 109. These data flows of FIG. 13 are basically similar to those of FIG. 10. Since a user manipulates a remote controller (not shown) so as to operate the 5.1-ch surround built-in television set 1307_2, the user instructs a surround reproducing operation executed by the 5.1-ch surround system. When this use instruction is entered, the central control unit 306 commences a control operation.

In FIG. 13, lines written by broken lines indicate flows of signals by a call control (SIP in this example). The central control unit 306 transmits a call setting command (“MakeCall”) to the IP-PBX 307, and then, the IP-PBX 307 connects-the sound source hard disk drive 1305_1 of the cradle 1302 to a 5.1-ch surround control unit 1310_2 of the television set 109 so as to establish a data path, and thus, the IP-PBX 307 causes these functional components to perform a P2P communication between thereon. Namely, a communication is carried out via the data path between IP communication units 1306_1 and 1311_2.

In contrast to the above-described signal flows, lines written by solid lines of FIG. 13 represent flows of control signals when the central control unit 306 operates the virtual 5.1-ch surround system. When the virtual 5.1-ch surround system is constructed, the central control unit 306 transmits both a power supply turn-ON instruction and a use instruction of the sound source hard disk drive 1305_1 with respect to the control unit 1303_1 of the cradle 1302_1. Further, the central control unit 306 transmits both a power supply turn-ON instruction and a use instruction of the sound control unit 1310_2 with respect to the control unit 1308_2 of the 5.1-ch surround built-in television set 1307_2. The use instruction is notified with respect to the IP communication units 1304_1 and 1309_2.

Upon receipt of the use instruction, the control unit 1303_1 initiates the sound source hard disk drive 1305_1 by turning ON the power supply unit thereof, and the control unit 1308_2 initiates the 5.1-ch surround control unit 1310_2 by turning ON the power supply unit thereof. Next, when the data path has been established, the sound source hard disk 1305_1 transmits such an IP packet that sound source data is employed as a payload from the IP communication unit 1306_1 to the 5.1-ch surround control unit 1310_2. The 5.1-ch surround control unit 1310_2 can drive the sound source data from the IP packet, and can transmit the derive sound source data to built-in speakers so as to output the sound source data.

A description is made of surround reproducing operation with reference to a flow chart shown in FIG. 14. Under the present situation, sound source data of the music player 1301_1 has been transferred so as to be held in the sound source hard disk drive 1305_1 of the cradle 1302_1. Upon receipt of a surround reproducing request, the central control unit 306 retrieves such a member which has held predetermined sound source data from the members of the hard disk drive group (step 1401). This member corresponds to the sound source hard disk drive 1305_1. If there is no such a member, then the surround reproducing operation fails.

Next, the central control unit 306 updates information as to a use situation of the sound source hard disk drive 1305_1 as under operation. Then, the central control unit 306 performs an IP communication with respect to the control unit 215_1 of the cradle 1302_1 installed on the first floor, which is equipped with the sound source hard disk drive 1305_1 as the functional component, in order to turn ON the power supply of the power supply unit thereof (step 1402).

Next, the central control unit 306 retrieves the 5.1-ch surround control unit 1310_2 connected to the 5.1-ch surround built-in television 1307_2 from the members of the 5.1-ch surround control unit group based upon the use situations of the respective functional components (step 1403).

Next, the central control unit 306 performs an IP communication with respect to the control unit 1308_2 of the 5.1-ch surround built-in television set 1307_2 installed on the second floor, which is equipped with the 5.1-ch surround control unit 1310_2 as the functional component, in order to turn ON the power supply of the power supply unit thereof (step 1404).

Next, in response to an instruction issued from the central control unit 306, the IP-PBX 307 gives such an instruction for causing the sound source hard disk drive 1305_1 to be connected to the 5.1-ch surround control unit 1310_2 in the P2P (Peer to Peer) communication manner based upon “NOTIFY” and “INVITE” (call control messages). As a result, the sound source hard disk drive 1305_1 and the 5.1-ch surround control unit 1310_2 perform the P2P communication operation (step 1405).

With execution of the P2P communication, the sound source hard disk drive 1305_1 transmits the held sound source data to the 5.1-ch surround control unit 1310_2 in order to perform surround reproducing operation from 6 pieces of speakers provided on the 5.1-ch surround built-in television set 1307_2 (step 1406).

Next, the central control unit 306 judges whether or not the surround reproducing operation is accomplished (step 1407).

If the surround reproducing operation is completed, then the IP-PBX 307 gives such a cut-off instruction of the P2P communication in response to an instruction issued from the central control unit 306. That is, the IP-PBX 307 instructs that both the sound source hard disk drive 1305_1 and the 5.1-ch surround control unit 1310_2 cut off the P2P communication based upon a call control message. As a result, both the sound source hard disk drive 1305_1 and the 5.1-ch surround control unit 1310_2 cut off the P2P communication (step 1408).

The central control unit 306 executes an IP communication with respect to both the control unit 1303_1 of the cradle 1302_1 installed on the first floor, and the control unit 1308_2 of the 5.1-ch surround built-in television set 1307_2 installed on the second floor in order to turn OFF the power supplies of the power supply units thereof (step 1409).

If there are no relevant functional components in the steps 1401 and 1404, then the process operation is accomplished under such a condition that the surround reproducing operation fails. Also, in such a case that the functional component must be released before the requirement for completing the surround reproducing operation has not yet been satisfied in the step 1407, the P2P communication is cut off (step 1410) so as to release the functional component (step 1411).

As previously described, in accordance with the embodiment 3, the data path is established based upon the call control using the IP-PBX 307 between the functional components (sound source hard disk drive 1305_1 and 5.1-ch surround control unit 1310_2) which construct the virtual 5.1-ch surround system, and further, the central control unit 306 performs the data transfer operation by utilizing the established data path. As a consequence, the central control unit 306 combines the functional components of the actually provided electronic apparatuses with each other so as to construct a single virtual electronic apparatus in appearance. Accordingly, the user can utilize this virtual 5.1-ch surround system, while the user need not pay his attention to the above-described actual situation.

### Embodiment 4

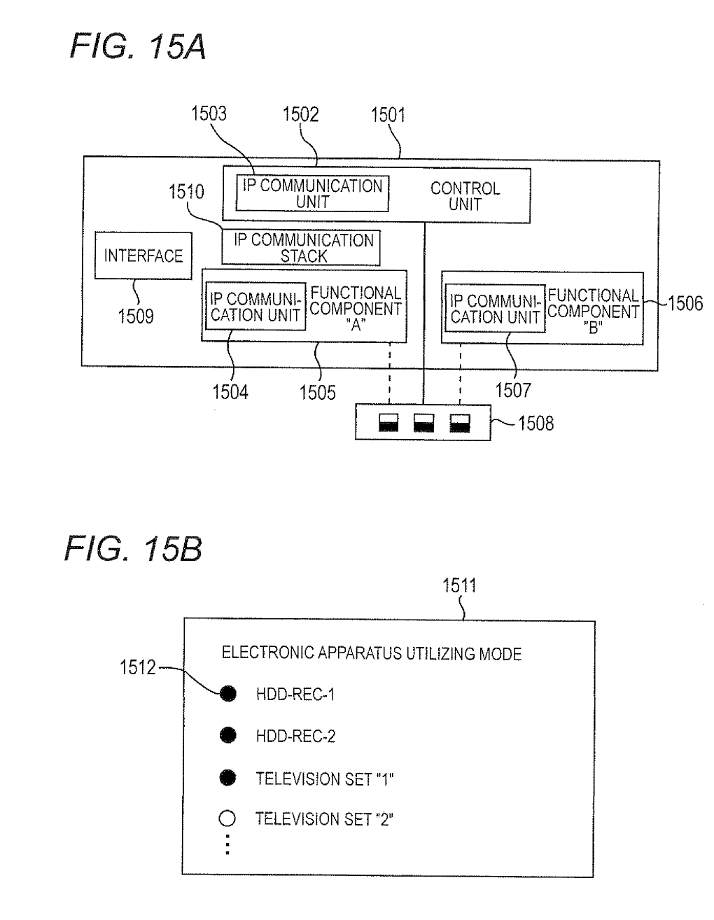

Referring now to FIG. 15, a description is made of an electronic apparatus and an electronic apparatus utilizing system using the electronic apparatus, according to an embodiment 4 of the present invention. FIG. 15A is an explanatory diagram for explaining a dip switch which switches utilizing modes of electronic apparatuses according to the embodiment 4 of the present invention, and FIG. 15B is an explanatory diagram for explaining a system setting unit which switches utilizing modes of an electronic apparatus utilizing system according to the embodiment 4 of the present invention. The remaining arrangement of the electronic apparatus utilizing system is similar to that of the embodiments 1 to 3.

In FIG. 15A, an electronic apparatus 1501 corresponds to electronic components which contain the HDD recording/reproducing apparatus 105, the HDD recording/reproducing apparatus 110, the FAX 106, the PC 107, the telephone 108, the television set 109, and the like, which are shown in FIG. 1. Also, an interface 1509 and an IP communication stack 1510 are provided in the electronic apparatus 1501. The interface 1509 is employed in order to be connected with a network. The IP communication stack 1510 has mounted thereon a software group so as to provide a network function.

Also, a control unit 1502 equipped with an IP communication unit 1503, a functional component “A” 1505, and another function component “B” 1506 are provided in the electronic apparatus 1501. Any of the functional component “A” 1505 and the functional component “B” 1506 is such a member belonging to a functional component group. An IP communication unit 1504 is provided in the functional component “A” 1505, and an IP communication unit 1507 is provided in the functional component “B” 1506. The IP communication unit 1503 has held an IP address in an IP address holding unit, whereas an IP communication unit 1504 and an IP communication unit 1507 have held functional component addresses in functional component address holding units. It should be noted that as to a total number of functional components, such an electronic component which has mounted thereon a larger number of functional components may be alternatively employed. Since these structural aspects of the embodiment 4 are identical to those of the above-described embodiments 1 to 3, explanations thereof will be omitted.

Further, as shown in FIG. 15A, a dip switch 1508 for switching electronic apparatus utilizing modes is provided in the electronic apparatus 1501. In other words, such a requirement is not always established that an electronic apparatus wants to commonly use functional components. As a consequence, the dip switch 1508 sets whether or not such a permission that this functional component is utilized by the entire system is made.

In the case that the functional component “A” 1505 and the functional component “B” 1506 are provided in order to construct a virtual electronic component, the operation mode of the dip switch 1508 is set to an entire control mode (“ON”) which permits the uses of these functional components “A” 1505 and “B” 1506. To the contrary, in such a case that the uses of the functional component “A” 1505 and the functional component “B” 1506 are not permitted so as to constitute the virtual electronic apparatus, the operation mode of the dip switch 1508 is set to an individual control mode (“OFF”). Since the mode setting operation is carried out, when the individual control mode is set, the IP communication unit 1503, the IP communication unit 1504, and the IP communication unit 1507 do not register such an information required for executing IP communications with respect to the IP-PBX 307.

As previously explained, while the dip switch 1508 is provided, the operation modes are physically switched with respect to the respective electronic components 1501, so that the functional components are not commonly used within a network, and thus, security can be secured. The dip switch 1508 is connected to the control unit 1502 so as to be utilized as a mode switching switch in the unit of an electronic component (housing). In the embodiment 4, although the provision of only such a dip switch 1508 connected to the control unit 1502 may become sufficient, setting modes may be alternatively changed in the unit of a functional component, as represented in broken lines of FIG. 15A. It should also be noted that the dip switch 1508 is not limited only to a physical switch, but may be alternatively realized by a software switch.

Next, FIG. 15B shows a setting field 1511 of the system setting unit of the central control unit 306 (refer to FIG. 3), while all the electronic components 1501 connected to the network have been registered in the setting field 1511, setting operations for the electronic apparatus utilizing modes (either entire control mode or individual control mode) can be changed based upon each of the electronic components 1501. In FIG. 15B, the setting operations are changed by a radio button 1512. When a setting operation of the setting field 1511 is turned OFF, the electronic apparatus 1501 whose operation mode has been turned OFF becomes the individual control mode. When the central control unit 306 judges that which functional component can be used, this judgement excludes the above-described electronic apparatus 1501. When a setting operation of the setting field 1511 is turned ON, the electronic apparatus 1501 becomes the entire control mode.

As previously described, in accordance with the embodiment 4, with respect to electronic apparatuses which can construct a virtual electronic apparatus, the below-mentioned two cases can be simply switched in accordance with a call control using the IP-PBX 307, namely, in one case, using of functional components is permitted, whereas in the other case, using of functional components is not permitted in order to construct the virtual electronic component. It is possible to freely set that the functional components are commonly utilized.

Many modifications and variations of the present invention are possible in the light of the above techniques. It is therefore to be understood that within the scope of the invention, the invention may be practiced than as specifically described. The present application is based upon and claims the benefit of priority of Japanese Patent Applications Nos. 2008-179849 filed on Jul. 10, 2008 and 2009-104984 filed on Apr. 23, 2009, the contents of which are incorporated herein by reference in its entirety.

What is claimed is:

1. An electronic apparatus comprising:
a control section that receives a request of a job;
a functional component that executes the job; and
a communication section by which the functional component communicates with another electronic apparatus via a network,
wherein the functional component executes the job together with a functional component provided in the another electronic apparatus by performing a data communication with the functional component of the another electronic apparatus by the communication section.

2. The electronic apparatus according to claim 1, wherein the functional component establishes a data path with the functional component of the another electronic apparatus, and performs the data communication with the functional component of the another electronic apparatus via the data path.

3. The electronic apparatus according to claim 1, wherein the control section transmits a message to a server via the network so that the server performs a call control with the functional component of the another electronic apparatus.

4. The electronic apparatus according to claim 3 wherein the control section transmits a message to a server via the network so that the server designates the functional component of the another electronic apparatus.

5. The electronic apparatus according to claim 4, wherein the server manages information on functional components of a plurality of electronic apparatuses via the network.

6. The electronic apparatus according to claim 5, wherein the communication section transmits the information on the functional components to the server.

7. The electronic apparatus according to claim 5, wherein the information on the functional components includes situation information of the functional components.

8. An electronic apparatus utilizing system, comprising:
a first electronic apparatus which includes:
a control section that receives a request of a job;
a first functional component that executes the job; and
a communication section by which the first functional component communicates via a network;
a second electronic apparatus which includes;
a second functional component that executes the job with the first functional component; and
a server that controls the first electronic apparatus and the second electronic apparatus,
wherein the control section transmits a message to the server via the network, and the server performs a call control with the second functional component, and the first functional component performs a data communication with the second functional component by the communication section.

9. The electronic apparatus utilizing system according to claim 8, wherein the control section transmits a message to the server via the network and the server designates the second functional component.

10. The electronic apparatus utilizing system according to claim 9, wherein the server manages information on functional components of a plurality of electronic apparatuses via the network.

11. The electronic apparatus utilizing system according to claim 10, wherein the functional components transmit the information on the functional components to the server by using the communication section.

12. The electronic apparatus utilizing system according to claim 10, wherein the information on the functional components includes situation information of the functional components.

13. A job executing method comprising:
receiving a request of a job;
communicating with another electronic apparatus via a network; and
executing the job together with a functional component provided in the another electronic apparatus by performing a data communication with the functional component of the another electronic apparatus by the communication section.

14. The job executing method according to claim 13, wherein:
a data path is established with the functional component of the another electronic apparatus, and the data communication is performed via the data path.

15. The job executing method according to claim 13, wherein a message is transmitted to a server via the network; and
wherein a call control is performed with the functional component of the another electronic apparatus by the server.

16. The job executing method according to claim 15, wherein the server designates the functional component of the another electronic apparatus.

17. The job executing method according to claim 16, wherein the server manages information on functional components of a plurality of electronic apparatuses via the network.

18. The job executing method according to claim 17, wherein the information on the functional components are transmitted from the functional components to the server.

19. The job executing method according to claim 17, wherein the information on the functional components includes situation information of the functional components.
